(19) United States
(12) Patent Application Publication
(10) Pub. No.: US 2019/0144114 A1
(43) Pub. Date: May 16, 2019

(54) SYSTEMS AND METHODS FOR CONTROLLING MOVABLE OBJECT BEHAVIOR

(71) Applicant: SZ DJI TECHNOLOGY CO., LTD., Shenzhen (CN)

(72) Inventors: Chaobin CHEN, Shenzhen (CN); Chang GENG, Shenzhen (CN)

(21) Appl. No.: 16/229,555

(22) Filed: Dec. 21, 2018

Related U.S. Application Data
(63) Continuation of application No. PCT/CN2016/086878, filed on Jun. 23, 2016.

(51) Int. Cl. B64C 39/02; G07C 5/06; G05D 1/00; G05D 1/10

(52) U.S. Cl. CPC B64C 39/024; G07C 5/06; G05D 1/0033; G05D 1/101; G05D 2201/0207; B64C 2201/127; B64C 2201/141; B64C 2201/146; B64C 2201/042

(57) ABSTRACT

A method for supporting application development in a movable object environment includes receiving a request to register one or more behavioral indicators for a movable object via a movable object controller, associating the one or more behavioral indicators with one or more indicator codes, and directing the movable object to behave based on an association between the one or more behavioral indicators and the one or more indicator codes.

### CROSS-REFERENCE TO RELATED APPLICATION

This application is a continuation of International Application No. PCT/CN2016/086878, filed on Jun. 23, 2016, the entire contents of which are incorporated herein by reference.

### BACKGROUND

Aerial vehicles such as unmanned aerial vehicles (UAVs) have a wide range of real-world applications including surveillance, reconnaissance, exploration, logistics transport, disaster relief, aerial photography, large-scale agriculture automation, live video broadcasting, etc. The number of creative uses for UAVs is growing as users develop various types of applications. In some cases, users may wish to observe whether a UAV is performing a specific task, and to distinguish between different tasks.

### SUMMARY

A need exists for systems and methods that enable behavioral indicators to be incorporated into a movable object environment. In some instances, a user who is remotely operating a movable object (e.g., a UAV) may wish to view an operational status of the UAV as an application is being executed. For example, the user may want to know whether the UAV is properly performing a specific task, or whether there are any issues (such as component malfunction) requiring the user's attention or intervention. The present disclosure addresses this need and provides related advantages as well.

According to embodiments of the disclosure, a software development kit (SDK) is provided. The SDK may be configured to allow one or more behavioral indicators to be incorporated into a movable object environment. The movable object environment may include a movable object, and one or more devices in communication with the movable object. The movable object can be, for example a UAV. One or more of the devices may be remote from or onboard the movable object. The behavioral indicators can be used to indicate an operational status of the movable object as one or more applications are being executed. The applications may be executed either autonomously by the movable object, or via a remote controller for controlling operation of the movable object. A user who is remotely operating the movable object from a distance may be able to determine, based on the behavior exhibited by the movable object, whether the UAV is properly performing a specific task in accordance with an application. In some instances, the behavioral indicators can be used to indicate whether there are any issues (such as component malfunction) requiring the user's attention or intervention. Users (e.g., software and/or application developers) can use the SDK to access different components (e.g., light-emitting elements, audio elements, propulsion units, flight control systems, electronic speed controls (ESCs), etc.) within the movable object environment, and develop different behavioral indicators using combinations of the components for a variety of applications.

In one aspect of the disclosure, a method for controlling a movable object is provided. The method may comprise: receiving, via a movable object manager on a device in operable communication with the movable object, one or more control signals for the movable object; obtaining, with aid of one or more processors individually or collectively, one or more indicator codes associated with the one or more control signals; and directing the movable object to behave based on the one or more indicator codes.

In some embodiments, the movable object may be directed to behave based on the one or more indicator codes when the movable object operates to perform one or more tasks defined by the control signals. The tasks may comprise at least one of the following: agriculture operation, aerial imagery, intelligent navigation, live video feed, autonomous flight, data collection and analysis, parking inspection, distance measurement, visual tracking, and/or environmental sensing. The movable object may be operated using a remote controller configured to receive a user input. Alternatively, the movable object may be autonomously operated using a flight controller onboard the movable object. The movable object may include an unmanned vehicle, a hand-held device, or a robot.

In some embodiments, the one or more indicator codes may be pre-registered on the device and/or the movable object. Alternatively, the one or more indicator codes may be obtained on the device when the device receives the one or more control signals. In some instances, the device may be configured to transmit said indicator codes and control signals to the movable object. In some cases, the one or more indicator codes may be provided with the one or more control signals to the device. Alternatively, the one or more indicator codes may be obtained onboard the movable object after said control signals have been transmitted to the movable object. The device may be located remotely from the movable object. Optionally, the device may be located onboard the movable object.

In some embodiments, the control signals and indicator codes may comprise sets of instructions for directing the movable object to behave in a plurality of predetermined manners. The plurality of predetermined manners may comprise a visual effect, an audio effect, and/or a motion effect. The visual effect may be generated by driving one or more light-emitting elements onboard the movable object. The one or more light-emitting elements may be configured to emit light of a same color or different colors. The visual effect may comprise a predetermined sequence of light flashes at a same time interval or at different time intervals. The audio effect may be generated by driving one or more acoustic elements onboard the movable object. The acoustic elements may comprise one or more speakers that are configured to emit sound of a same frequency or different frequencies. The audio effect may comprise a predetermined sequence of sounds at a same time interval or different time intervals. The motion effect may be generated by driving one or more propulsion units onboard the movable object to result in (1) a motion pattern of the movable object, or (2) movement of the movable object along a predetermined motion path. The motion pattern may comprise a pitch, roll, and/or yaw motion of the movable object.

In some embodiments, a method may further comprise: with aid of the one or more processors individually or collectively, (1) determining whether each of the one or more control signals is executable by the movable object based on a hardware configuration of the movable object, and (2) obtaining the one or more indicator codes associated with the one or more control signals that are executable by the movable object. The method may further comprise: determining, with aid of the one or more processors individually or collectively, whether the one or more control signals conflict with one or more pre-existing indicator signals that are stored on the movable object. The pre-existing indicator signals may be preset by a manufacturer or a distributor of the movable object.

In some embodiments, when a control signal is determined to conflict with the one or more pre-existing indicator signals, the one or more processors may be individually or collectively configured to: (1) reject the control signal; (2) modify the control signal such that the control signal does not conflict with the one or more pre-existing indicator signals, or (3) assign a lower priority level to the control signal and the corresponding indicator code, such that the control signal does not conflict with the pre-existing indicator signal.

A system for controlling a movable object is provided in accordance with another aspect of the disclosure. The system may comprise: a movable object manager on a device configured to receive one or more control signals for the movable object, wherein said device is in operable communication with the movable object; and one or more processors that are individually or collectively configured to: (1) obtain one or more indicator codes associated with the one or more control signals, and (2) direct the movable object to behave based on the one or more indicator codes.

In another aspect of the disclosure, a non-transitory computer-readable medium storing instructions that, when executed, causes one or more processors to individually or collectively perform a method for controlling a movable object is provided. The method may comprise: receiving, via a movable object manager on a device in operable communication with the movable object, one or more control signals for the movable object; obtaining, with aid of one or more processors individually or collectively, one or more indicator codes associated with the one or more control signals; and directing the movable object to behave based on the one or more indicator codes.

A method for supporting application development in a movable object environment is provided in accordance with a further aspect of the disclosure. The method may comprise: receiving, via a movable object controller, a request to register one or more behavioral indicators for a movable object; associating the one or more behavioral indicators with one or more indicator codes; and directing the movable object to behave based on the association between the one or more behavioral indicators and the one or more indicator codes.

In some embodiments, the movable object may be directed to behave based on said association when the movable object operates to perform one or more tasks defined by one or more control signals. The movable object may be operated using a remote controller configured to receive a user input. The tasks may comprise at least one of the following: agriculture operation, aerial imagery, intelligent navigation, live video feed, autonomous flight, data collection and analysis, parking inspection, distance measurement, visual tracking, and/or environmental sensing. Alternatively, the movable object may be autonomously operated using a flight controller onboard the movable object. The movable object may include an unmanned vehicle, a hand-held device, or a robot.

In some embodiments, the indicator codes may be pre-registered on the movable object. The behavioral indicators may be associated with said indicator codes using one or more processors located onboard the movable object. The movable object may be configured to transmit the associated indicator codes to a device via the movable object controller. In some instances, the behavioral indicators may be associated with said indicator codes using one or more processors located on a device. The device may be configured to transmit the associated indicator codes to the movable object via the movable object controller. The device may be located remotely from the movable object. Alternatively, the device may be located onboard the movable object. In some embodiments, the behavioral indicators may be associated with said indicator codes using the movable object controller.

The behavioral indicators and indicator codes may comprise sets of instructions for directing the movable object to behave in a plurality of predetermined manners. The predetermined manners comprise a visual effect, an audio effect, and/or a motion effect. The visual effect may be generated by driving one or more light-emitting elements onboard the movable object. The one or more light-emitting elements may be configured to emit light of a same color or different colors. The visual effect may comprise a predetermined sequence of light flashes at a same time interval or at different time intervals. The audio effect may be generated by driving one or more acoustic elements onboard the movable object. The acoustic elements may comprise one or more speakers that are configured to emit sound of a same frequency or different frequencies. The audio effect may comprise a predetermined sequence of sounds at a same time interval or different time intervals. The motion effect may be generated by driving one or more propulsion units onboard the movable object to result in (1) a motion pattern of the movable object, or (2) movement of the movable object along a predetermined motion path. The motion pattern may comprise a pitch, roll, and/or yaw motion of the movable object.

In some embodiments, the behavioral indicators and indicator codes may be provided in a look-up table and stored in a memory unit accessible by the movable object controller. The movable object controller may be in communication with one or more applications via a movable object manager comprising a communication adaptor. In some embodiments, the movable object may be an unmanned aircraft, and wherein the communication adaptor may comprise a camera component, a battery component, a gimbal component, a communication component, and a flight controller component. The communication adaptor may comprise a ground station component that is associated with the flight controller component, and wherein the ground station component may operate to perform one or more flight control operations.

A system for supporting application development in a movable object environment is provided in another aspect of the disclosure. The system may comprise a movable object controller configured to: receive a request to register one or more behavioral indicators for a movable object; associate the one or more behavioral indicators with one or more indicator codes; and direct the movable object to behave based on the association between the one or more behavioral indicators and the one or more indicator codes.

In a further aspect of the disclosure, a non-transitory computer-readable medium storing instructions that, when executed, causes one or more processors to individually or collectively perform a method for supporting application development in a movable object environment is provided. The method may comprise: receiving a request to register one or more behavioral indicators for a movable object; associating the one or more behavioral indicators with one or more indicator codes; and directing the movable object to behave based on the association between the one or more behavioral indicators and the one or more indicator codes.

It shall be understood that different aspects of the disclosure can be appreciated individually, collectively, or in combination with each other. Various aspects of the disclosure described herein may be applied to any of the particular applications set forth below or for any other types of movable objects. Any description herein of an aerial vehicle may apply to and be used for any movable object, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is an exemplary illustration of an application in a movable object environment, in accordance with various embodiments of the disclosure.

FIG. 2 is an exemplary illustration of supporting software application development in a movable object environment, in accordance with various embodiments of the disclosure.

FIG. 3 illustrates a software development environment in which a movable object manager is configured to manage communication between a movable object and a remote device, in accordance with some embodiments.

FIG. 4 illustrates the transmission of behavioral indicators and indicator codes from a remote device to a movable object, in accordance with some embodiments.

FIG. 5 illustrates the transmission of indicator codes from a movable object back to a remote device, in accordance with some other embodiments.

FIG. 6 illustrates a software development environment in which a movable object manager is configured to manage communication between a movable object and an onboard device to register a behavior table, in accordance with some embodiments.

FIG. 7 illustrates the generation of a behavior table onboard a movable object, in accordance with some embodiments.

FIG. 8 illustrates the transmission of indicator codes back to an onboard device, in accordance with some other embodiments.

FIG. 9 illustrates a software development environment in which a movable object manager is configured to manage communication between different movable objects to register a behavior table, in accordance with some embodiments.

FIG. 10 illustrates one-way registration of a behavior table from one movable object to another movable object, in accordance with some embodiments.

FIG. 11 illustrates two-way registration of behavior tables from one movable object to another movable object, in accordance with some embodiments.

FIG. 12 illustrate the generation of different behaviors using one or more modules in a movable object, in accordance with some embodiments.

FIG. 13 illustrates a behavior table in accordance with some embodiments.

FIG. 14 illustrates a movable object displaying a visual effect to a remote user as the movable object is performing one or more tasks, in accordance with some embodiments.

FIG. 15 illustrates a movable object generating an audio effect to a remote user as the movable object is performing one or more tasks, in accordance with some embodiments.

FIG. 16 illustrates a movable object exhibiting a motion pattern to a remote user as the movable object is performing one or more tasks, in accordance with some embodiments.

FIG. 17 illustrates a movable object exhibiting a motion pattern along a predetermined motion path to a remote user as the movable object is performing one or more tasks, in accordance with some embodiments.

FIG. 18 illustrates a plurality of movable objects exhibiting different motion effects along different predetermined motion paths to a remote user as the movable objects are performing different tasks, in accordance with some embodiments.

FIG. 19 illustrates a flowchart of a method for controlling a movable object in accordance with some embodiments.

FIG. 20 illustrates a flowchart of a method for controlling a movable object in accordance with some embodiments.

FIG. 21 illustrates a method of controlling a movable object based on whether a control signal conflicts with a pre-existing indicator signal, in accordance with some embodiments.

FIG. 22 is a schematic block diagram of a system for controlling a movable object, in accordance with some embodiments.

### DETAILED DESCRIPTION

The systems and methods disclosed herein relate to the use of behavioral indicators for applications within a movable object environment. This may be achieved using, for example a software development kit (SDK) for the movable object environment. The SDK can be used by a user to develop different applications and behavioral indicators for a movable object.

The movable object environment may include a movable object, and one or more devices in communication with the movable object. The movable object can be, for example a UAV, a handheld device, or a robot. One or more of the devices may be remote from or onboard the movable object. The behavioral indicators are used to indicate an operational status of the movable object as one or more applications are being executed. The application(s) may be executed either autonomously by the movable object, or via a remote controller for controlling operation of the movable object. A user who is remotely operating the movable object from a distance may be able to determine, based on the behavior exhibited by the movable object, whether the UAV is properly performing a specific task in accordance with an application. In some instances, the behavioral indicators can be used to indicate whether there are any issues (such as component malfunction) requiring the user's attention or intervention. Users (e.g., software and/or application developers) can use the SDK to access different components (e.g., light-emitting elements, audio elements, propulsion units, flight control systems, electronic speed controls (ESCs), etc.) within the movable object environment, and develop different behavioral indicators using combinations of the components for a variety of applications.

It shall be understood that different aspects of the disclosure can be appreciated individually, collectively, or in combination with each other. Various aspects of the disclosure described herein may be applied to any of the particular applications set forth below or for any other types of remotely controlled vehicles or movable objects.

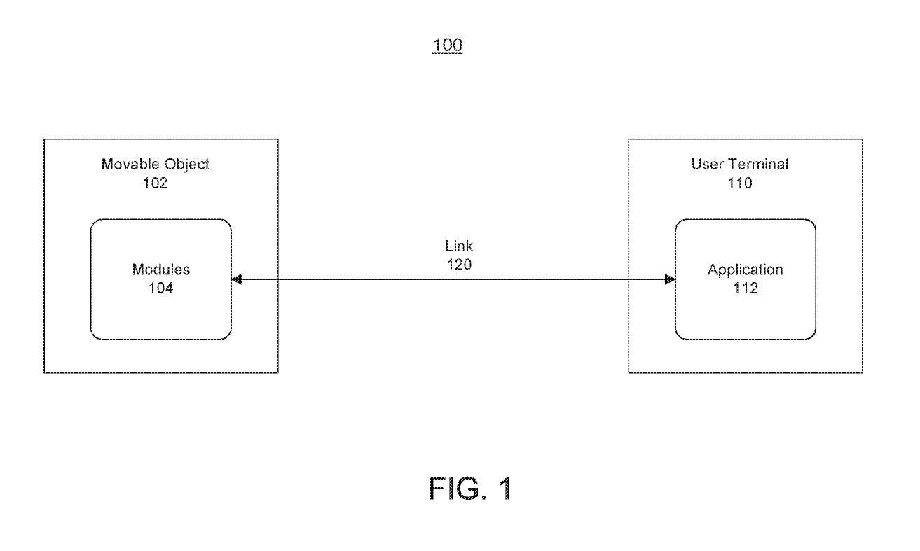

FIG. 1 is an exemplary illustration of an application in a movable object environment, in accordance with various embodiments of the disclosure. As shown in FIG. 1, a movable object environment 100 may comprise a movable object 102 and a user terminal 110. The movable object and the user terminal may be in communication with each other via a link 120. The link may comprise wired and/or wireless communication channels.

The movable object may be any object capable of traversing a physical environment. The movable object may be capable of traversing air, water, land, and/or space. The physical environment may include objects that are incapable of motion (stationary objects) and objects that are capable of motion. Examples of stationary objects may include geographic features, plants, landmarks, buildings, monolithic structures, or any fixed structures. Examples of objects that are capable of motion include people, vehicles, animals, projectiles, etc.

In some cases, the physical environment may be an inertial reference frame. The inertial reference frame may be used to describe time and space homogeneously, isotropically, and in a time-independent manner. The inertial reference frame may be established relative to the movable object, and move in accordance with the movable object. Measurements in the inertial reference frame can be converted to measurements in another reference frame (e.g., a global reference frame) by a transformation (e.g., Galilean transformation in Newtonian physics).

The movable object may be a vehicle, a handheld device, and/or a robot. The vehicle may be a self-propelled vehicle. The vehicle may traverse the environment with aid of one or more propulsion units. The vehicle may be an aerial vehicle, a land-based vehicle, a water-based vehicle, or a space-based vehicle. The vehicle may be an unmanned vehicle. The vehicle may be capable of traversing the environment without a human passenger onboard. Alternatively, the vehicle may carry a human passenger. In some embodiments, the movable object may be an unmanned aerial vehicle (UAV). Any description herein of a UAV or any other type of movable object may apply to any other type of movable object or various categories of movable objects in general, or vice versa. For instance, any description herein of a UAV may apply to any unmanned land-bound, water-based, or space-based vehicle. Further examples of movable objects are provided in greater detail elsewhere herein.

As mentioned above, the movable object may be capable of traversing a physical environment. The movable object may be capable of flight within three dimensions. The movable object may be capable of spatial translation along one, two, or three axes. The one, two or three axes may be orthogonal to one another. The axes may be along a pitch, yaw, and/or roll axis. The movable object may be capable of rotation about one, two, or three axes. The one, two, or three axes may be orthogonal to one another. The axes may be a pitch, yaw, and/or roll axis. The movable object may be capable of movement along up to 6 degrees of freedom. The movable object may include one or more propulsion units that may aid the movable object in movement. For instance, the movable object may be a UAV with one, two or more propulsion units. The propulsion units may be configured to generate lift for the UAV. The propulsion units may include rotors. The movable object may be a multi-rotor UAV.

The movable object may have any physical configuration. For instance, the movable object may have a central body with one or arms or branches extending from the central body. The arms may extend laterally or radially from the central body. The arms may be movable relative to the central body or may be stationary relative to the central body. The arms may support one or more propulsion units. For instance, each arm may support one, two or more propulsion units.

The movable object 102 can include one or more functional modules 104. The modules may include electrical components, such as a flight controller, one or more processors, one or more memory storage units, one or more sensors (e.g., one or more inertial sensors or any other type of sensor described elsewhere herein), one or more navigational units (e.g., a global positioning system (GPS) unit), one or communication units, one or more light-emitting elements, one or more audio speakers, or any other type of component. For example, in some embodiments, the movable object (such as a UAV) can include a flight control module, a battery module, a gimbal module, a camera module, a communication module, etc.

A flight control module may include a flight controller. The flight controller may be in communication with one or more propulsion units of the UAV, and/or may control operation of the one or more propulsion units. The flight controller may communicate and/or control operation of the one or more propulsion units with aid of one or more electronic speed control (ESC) modules. The flight controller may communicate with the ESC modules to control operation of the propulsion units.

A battery module may comprise a battery. The battery may be integrated with the movable object. Alternatively or in addition, the battery may be a replaceable component that is removably coupled with the movable object. A battery may comprise a lithium battery, or a lithium ion battery. In some embodiments, the battery module may be a battery assembly (or a battery pack) and may comprise a plurality of battery cells. While batteries, or battery assemblies are primarily discussed herein, it is to be understood that any alternative power source or medium of storing energy, such as supercapacitors may be equally applicable to the present disclosure. In some cases, the battery module may further include a power controller. The power controller may in some instances be a microcontroller located on board the battery, e.g. as part of an intelligent battery system. In some instances, parameters regarding the battery (e.g., voltage, voltage drop, current, temperature, remaining capacity) may be sensed with aid of the power controller. Alternatively, the battery parameters may be estimated using a separate sensing means (e.g. voltmeter, multi-meter, battery level detector, etc).

A gimbal module may comprise a carrier. The carrier may include one or more gimbal stages that permit movement of the carrier relative to the movable object. For instance, the carrier may include a first gimbal stage that may permit rotation of the carrier relative to the movable object about a first axis, a second gimbal stage that may permit rotation of the carrier relative to the movable object about a second axis, and/or a third gimbal stage that may permit rotation of the carrier relative to the movable object about a third axis. Any descriptions and/or characteristics of carriers as described elsewhere herein may apply.

The carrier may be configured to support a payload. The payload may be movable relative to the movable object with aid of the carrier. The payload may spatially translate relative to the movable object. For instance, the payload may move along one, two or three axes relative to the movable object. The payload may rotate relative to the movable object. For instance, the payload may rotate about one, two or three axes relative to the movable object. The axes may be orthogonal to on another. The axes may be a pitch, yaw, and/or roll axis. Alternatively, the payload may have a fixed position relative to the movable object. For example, the payload may be fixed or integrated into the movable object, either via the carrier on directly onto the movable object.

A payload may include one or more types of sensors. The payload may be controlled in a variety of ways using different applications to perform one or more of the following tasks, for example: agriculture operation, aerial imagery, intelligent navigation, live video feed, autonomous flight, data collection and analysis, parking inspection, distance measurement, visual tracking, and/or environmental sensing. The applications may be developed and/or customized by users using a Software Development Kit (SDK). A SDK can be used to boost more creative uses of UAVs, by allowing users to generate customized applications on aerial platforms. For example, a user can use a SDK to create applications that control the interaction between different components (e.g., different sensors, camera, gimbal, flight control system, remote controller, etc.) of a UAV to perform various tasks. A SDK typically allows a user to access and send commands to one or more UAV components via an application programming interface (API).

Some examples of types of sensors may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors). One or more sensors in the payload can be accessed and/or controlled via various applications that are developed using a SDK. For example, an application directed to parking inspection may utilize location sensors for determining locations of available parking lots, vision sensors and/or proximity sensors for detecting whether a lot is available or occupied, etc.

The payload may include one or more devices capable of emitting a signal into an environment. For instance, the payload may include an emitter along an electromagnetic spectrum (e.g., visible light emitter, ultraviolet emitter, infrared emitter). The payload may include a laser or any other type of electromagnetic emitter. The payload may emit one or more vibrations, such as ultrasonic signals. The payload may emit audible sounds (e.g., from a speaker). The payload may emit wireless signals, such as radio signals or other types of signals. Similarly, one or more of the above-mentioned devices can be accessed and/or controlled via various applications to generate a visual effect and/or audio effect as described elsewhere herein. The visual effect and/or audio effect can be used to indicate an operational status of a movable object to a user, as the movable object is performing one or more tasks specified by one or more applications.

The payload may be capable of interacting with the environment. For instance, the payload may include a robotic arm. The payload may include an item for delivery, such as a liquid, gas, and/or solid component. For example, the payload may include pesticides, water, fertilizer, fire-repellant materials, food, packages, or any other item. Various applications may be developed for a UAV to utilize its robotic arm to deliver materials to and/or at a target. For example, an application directed to agriculture operation may utilize a robotic arm on a UAV to deliver pesticides, water, or fertilizer over a wide agricultural area.

Any examples herein of payloads may apply to devices that may be carried by the movable object or that may be part of the movable object. For instance, one or more sensors may be part of the movable object. The one or more sensors may or may be provided in addition to the payload. This may apply for any type of payload, such as those described herein.

In some embodiments, a payload may include a camera module. Applications may be developed using the camera module to perform a variety of autonomous or semi-autonomous tasks. For example, the applications can control the camera module to enable visual tracking of a target, environmental sensing/perception, flight navigation, visual object recognition, facial detection, photography or videography of indoor or outdoor events (e.g., sporting events, concerts, special occasions such as a weddings), real-time aerial news coverage, etc.

The camera module may include any physical imaging device that is capable of detecting electromagnetic radiation (e.g., visible, infrared, and/or ultraviolet light) and generating image data based on the detected electromagnetic radiation. An imaging device may include a charge-coupled device (CCD) sensor or a complementary metal-oxide-semiconductor (CMOS) sensor that generates electrical signals in response to wavelengths of light. The resultant electrical signals can be processed to produce image data. The image data generated by an imaging device can include one or more images, which may be static images (e.g., photographs), dynamic images (e.g., video), or suitable combinations thereof. The image data can be polychromatic (e.g., RGB, CMYK, HSV) or monochromatic (e.g., grayscale, black-and-white, sepia). An imaging device may include a lens configured to direct light onto an image sensor.

An imaging device can be a camera. A camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable imaging device, and any description herein relating to cameras can also be applied to any suitable imaging device, and any description herein relating to cameras can also be applied to other types of imaging devices. The camera may comprise optical elements (e.g., lens, mirrors, filters, etc). The camera may capture color images, greyscale image, infrared images, and the like. The camera may be a thermal imaging device when it is configured to capture infrared images.

In some applications, a camera can be used to generate 2D images of a 3D scene (e.g., an environment, one or more objects, etc.). The images generated by the camera can represent the projection of the 3D scene onto a 2D image plane. Accordingly, each point in the 2D image corresponds to a 3D spatial coordinate in the scene.

In some alternative embodiments, an imaging device may extend beyond a physical imaging device. For example, an imaging device may include any technique that is capable of capturing and/or generating images or video frames. In some embodiments, the imaging device may refer to an algorithm that is capable of processing images obtained from another physical device.

In some embodiments, the payload may include multiple imaging devices, or an imaging device with multiple lenses and/or image sensors. Applications may be developed to control the payload to capture multiple images substantially simultaneously, sequentially, or at different points in time. In some cases, the applications can use the multiple images to create a 3D scene, a 3D virtual environment, a 3D map, or a 3D model. For instance, a right-eye image and a left-eye image may be taken and used for stereo-mapping. A depth map may be calculated from a calibrated binocular image. Any number of images (e.g., 2 or more, 3 or more, 4 or more, 5 or more, 6 or more, 7 or more, 8 or more, 9 or more) may be taken simultaneously to aid in the creation of a 3D scene/virtual environment/model, and/or for depth mapping. The images may be directed in substantially the same direction or may be directed in slightly different directions. In some instances, data from other sensors (e.g., ultrasonic data, LIDAR data, data from any other sensors as described elsewhere herein, or data from external devices) may aid in the creation of a 2D or 3D image or map.

A communication module may include one or more communication units onboard the movable object. Similarly, one or more communication units may be provided at the user terminal. The movable object may be capable of communicating with the user terminal using the one or more communication units. The user terminal 110 may communicate with one or more modules 104 of the movable object. For example, the user terminal may communicate with the movable object itself, with a payload of the movable object, and/or with a carrier of the movable object, whereby the carrier is used to support the payload. Any description herein of communications with the movable object may also apply to communications with the payload of the movable object, the carrier of the movable object, and/or one or more individual components of the movable object (e.g., communication unit, navigation unit, propulsion units, power source, processors, memory storage units, and/or actuators).

The link 120 may enable wired and/or wireless communications between the movable object and the user terminal. The communications can include uplink and downlink. The uplink can be used for transmitting control signals, the down link can be used for transmitting media or video stream. Direct communications may be provided between the movable object and the user terminal. The direct communications may occur without requiring any intermediary device or network. Indirect communications may be provided between the movable object and the user terminal. The indirect communications may occur with aid of one or more intermediary device or network. For instance, indirect communications may utilize a telecommunications network. Indirect communications may be performed with aid of one or more router, communication tower, satellite, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, or Long Term Evolution (LTE) protocols, Infra-Red (IR) communication technologies, and/or Wi-Fi, and may be wireless, wired, or a combination thereof.

The user terminal 110 may be any type of external device. Examples of user terminals may include, but are not limited to, smartphones/cellphones, tablets, personal digital assistants (PDAs), laptop computers, desktop computers, media content players, video gaming station/system, virtual reality systems, augmented reality systems, wearable devices (e.g., watches, glasses, gloves, headgear (such as hats, helmets, virtual reality headsets, augmented reality headsets, head-mounted devices (HMD), headbands), pendants, armbands, leg bands, shoes, vests), gesture-recognition devices, microphones, any electronic device capable of providing or rendering image data, or any other type of device. The user terminal may be a handheld object. The user terminal may be portable. The user terminal may be carried by a human user. The user terminal may be worn by a human user. In some cases, the user terminal may be located remotely from a human user, and the user can control the user terminal using wireless and/or wired communications. Various examples, and/or characteristics of user terminal are provided in greater detail elsewhere herein.

A user terminal may include one or more processors that may be capable of executing non-transitory computer readable media that may provide instructions for one or more actions. The user terminal may include one or more memory storage devices comprising non-transitory computer readable media including code, logic, or instructions for performing the one or more actions. The user terminal may include software applications that allow the user terminal to communicate with and receive imaging data from a movable object. The user terminal may include a communication unit, which may permit the communications with the movable object. In some instances, the communication unit may include a single communication module, or multiple communication modules. In some instances, the user terminal may be capable of interacting with the movable object using a single communication link or multiple different types of communication links.

The user terminal may include a display (or display device). The display may be a screen. The display may or may not be a touchscreen. The display may be a light-emitting diode (LED) screen, OLED screen, liquid crystal display (LCD) screen, plasma screen, or any other type of screen. The display may be configured to show a graphical user interface (GUI). The GUI may show an image that may permit a user to control actions of the UAV. In some instances, the user may select a target from the image. The target may be a stationary target or a moving target. In other instances, the user may select a direction of travel from the image. The user may select a portion of the image (e.g., point, region, and/or object) to define the target and/or direction. The user may select the target and/or direction by changing the focus and/or direction of the user's gaze point on the screen (e.g., based on eye-tracking of the user's regions of interest). In some cases, the user may select the target and/or direction by moving his or her head in different directions and manners.

A user may touch a portion of the screen. The user may touch the portion of the screen by touching a point on the screen. Alternatively, the user may select a region on a screen from a pre-existing set of regions, or may draw a boundary for a region, a diameter of a region, or specify a portion of the screen in any other way. The user may select the target and/or direction by selecting the portion of the image with aid of a user interactive device (e.g., mouse, joystick, keyboard, trackball, touchpad, button, verbal commands, gesture-recognition, attitude sensor, thermal sensor, touch-capacitive sensors, or any other device). A touchscreen may be configured to detect location of the user's touch, length of touch, pressure of touch, and/or touch motion, whereby each of the aforementioned manner of touch may be indicative of a specific input command from the user.

The user terminal may be used to control the movement of the movable object, such as flight of a UAV. The user terminal may permit a user to manually directly control flight of the movable object. Alternatively, a separate device may be provided that may allow a user to manually directly control flight of the movable object. The separate device may or may not be in communication with the user terminal. The flight of the movable object may optionally be fully autonomous or semi-autonomous. The user terminal may optionally be used to control any component of the movable object (e.g., operation of the payload, operation of the carrier, one or more sensors, communications, navigation, landing stand, actuation of one or more components, power supply control, or any other function). Alternatively, a separate device may be used to control one or more components of the movable object. The separate device may or may not be in communication with the user terminal. One or more components may be controlled automatically with aid of one or more processors.

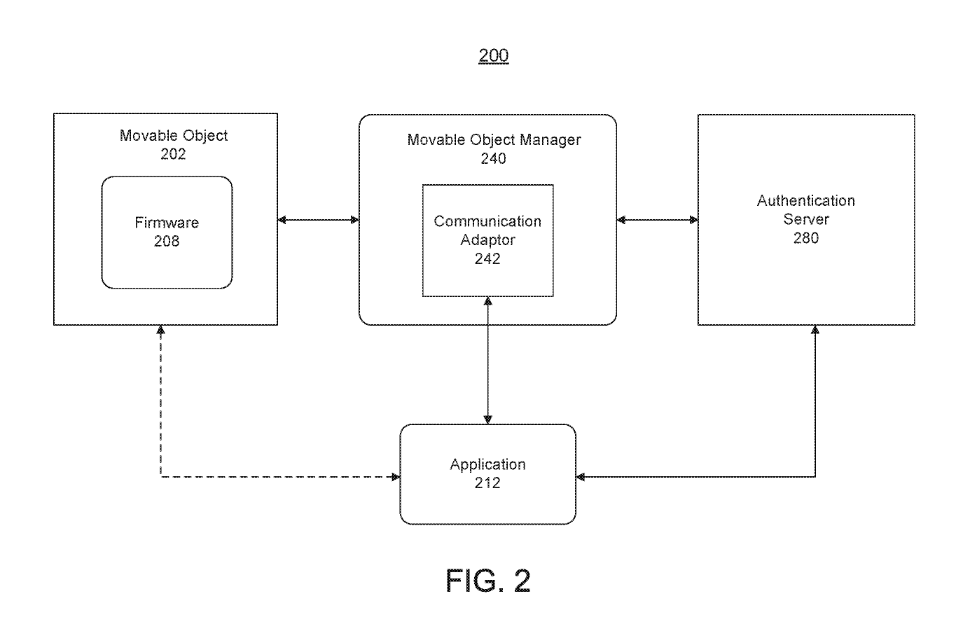

As shown in FIG. 1, an application 112 can be deployed on the user terminal 110. The application can communicate with the movable object using any of the communication methods described elsewhere herein. The application can be used to access one or more functional modules 104 of the movable object. The application will be described in more detail below with reference to FIG. 2.

FIG. 2 is an exemplary illustration of supporting software application development in a movable object environment, in accordance with various embodiments of the disclosure. As shown in FIG. 2, an application 212 in a movable object environment 200 can use a movable object manager 240 for accessing and controlling a movable object 202, e.g. via a movable object controller. The movable object controller may include a combination of hardware and/or software. For example, the movable object 202 can include firmware 208 for controlling various functional modules (e.g., modules 104 in FIG. 1) in the movable object. The firmware 208 may be included in the movable object controller in whole or in part. In some embodiments, the movable object controller may be integrated with the movable object manager. The movable object controller may also form part of the movable object manager. Optionally, the movable object controller and the movable object manager may be separately provided, and configured to be in communication with each other. The movable object can be an unmanned aircraft, an unmanned vehicle, a portable computing device, a hand-held device, or a robot. In some embodiments, the movable object manager 240 can be part of a software development kit (SDK), which is used for supporting the development of software applications in the movable object environment 200.

A SDK as used herein can provide access to functional modules of a movable object (e.g., a UAV) to an application. An application can be developed by a third party entity that is different from a manufacturer of the movable object or a manufacturer of a user terminal (e.g., a mobile device). The third party entity may be a user (e.g., software developer) or a company that develops applications. Optionally, an application can also be developed a manufacturer of the movable object or a manufacturer of a user terminal (e.g., a mobile device). An application may be programmed to run on a user terminal. In some embodiments, an application can include executable computer programmable codes that are implementable on the user terminal (or any computing device), and executable using one or more operating systems.

In some embodiments, applications may be provided in different layers, with one or more third-party applications executable with a main application. For example, in some instances, a user terminal may be installed with a main application that is provided by a manufacturer or distributor of a UAV. The main application may be a factory pre-set application that is downloadable from the UAV manufacturer's website or other Internet sources, or installed on the user terminal using any computer readable storage medium (e.g., CDs, flash memory, etc.). In some cases, the main application may need to be installed on the user terminal first, in order for a user to control the UAV using the main application. One or third-party applications may be configured to run (execute), either concurrently and/or cooperatively, with the main application. In some cases, the main application may need to be running first before the one or third-party applications can run. Alternatively, in other cases, the main application need not be running when the one or third-party applications are running (i.e., the third-party applications are capable of running on their own without the main application). In some embodiments, a third-party application may modify aspects of the main application, or even replace the main application. In some embodiments, a third-party application may have to be approved by another entity (e.g., a manufacturer or distributor of the movable object, a government agency, etc.) before the third-party application can be used with the movable object (e.g., UAV). In some cases, the movable object can be operated via a third-party application only upon authenticating and/or verifying that the third-party application has been previously approved. The authentication/verification steps may be performed using executable codes that are implemented on the user terminal and/or the movable object. In some cases, instructions may only be transmitted from the third-party application to the movable object upon successful authentication and/or verification of the status of the third-party application.

In some embodiments, a third-party application may include one or more graphical elements that are embedded within a control interface provided by the main application. In some embodiments, a third-party mobile application can be coupled to a third-party cloud-based service that stores and/or processes data transmitted from the movable object.

In some embodiments, one or more third-party applications may be configured to run directly onboard a movable object. The movable object may include an onboard factory-preset control application that is configured to operate various functional modules of the movable object. The control application can allow the movable object to navigate and to communicate with the user terminal via the main application. One or more third-party applications can run within the control application. Additionally, one or more third-party applications can provide updates to the control application. In some embodiments, one or more third-party applications can run, either concurrently and/or cooperatively, with the control application to operate the movable object. In some embodiments, the control application may be configured to execute the one or more third-party applications. The control application can be implemented using a combination of software and hardware (e.g., an application-specific integrated circuit or a field programmable gate array).

The control application may need to be running first before the one or third-party applications can run. In some embodiments, a third-party application may modify aspects of the control application, or even replace the control application. In some embodiments, a third-party application may have to be approved by another entity (e.g., a manufacturer or distributor of the movable object, a government agency, etc.) before the third-party application can be used with the movable object (e.g., UAV). In some cases, the movable object can be operated via a third-party application only upon authenticating and/or verifying that the third-party application has been previously approved. The authentication/verification steps may be performed using executable codes that are implemented on the user terminal and/or the movable object. In some cases, instructions may only be transmitted from the third-party application to the movable object upon successful authentication and/or verification of the status of the third-party application.

As shown FIG. 2, the movable object manager 240 can establish a connection with the movable object 202, and manage communications between the application 212 and the movable object 202. For example, the movable object manager can receive one or more data packets from the movable object, and provide information contained in the one or more data packets to the application. Also, the movable object manager can receive one or more commands from the application, and send the one or more commands to the movable object.

The movable object manager 240 may be provided at different places within the movable object environment 200. For example, the movable object manager may be provided on a user terminal (e.g., user terminal 110 of FIG. 1) where the application is deployed. Alternatively, the movable object manager may be provided on a remote server, a communication device, or directly on the movable object.

In some embodiments, an authentication server 280 may be configured to provide a security model for supporting the application development in the movable object environment 200.

The movable object manager 240 may further include a data manager and a communication manager (not shown). The data manager can be used for managing the data exchange between the application and the movable object. The communication manger can be used for handling one or more data packets that are associated with a communication protocol. The communication protocol can include a data link layer, a network layer, and an application layer. The data link layer can be configured to handle data framing, data check, and data retransmission. The network layer can be configured to support data packets routing and relaying. The application layer can be configured to handle various application logics, such as controlling the behavior of various functional modules in the movable object.

The communication protocol can support the communication between various modules within the movable object, such as a flight imaging system which can include a camera, a flight remote control, a gimbal, a digital media processor, a circuit board, etc. Furthermore, the communication protocol can be used with different physical link technologies, such as the universal asynchronous receiver/transmitter (UART) technology, the controller area network (CAN) technology, and the inter-integrated circuit (I2C) technology.

The application 212 can access the movable object manager 240 via a communication adaptor 242. The communication adaptor in the movable object manager may be representative of the movable object 202. Accordingly, the application 212 (or a plurality of applications) can access and control the movable object via the movable object manager or the communication adaptor. In some embodiments, the movable object manager may include the communication adaptor. The communication adaptor may serve as an interface to one or more devices (e.g., a user terminal, a remote controller, etc.).

In some embodiments, the movable object is a UAV comprising a plurality of modules which may include a camera module, a battery module, a gimbal module, and a flight controller module. In a corresponding fashion, the communication adaptor 242 can include a camera component, a battery component, a gimbal component, and a flight controller component. Additionally, the communication adaptor 242 can include a ground station component which is associated with the flight controller component. The ground station component may operate to perform one or more flight control operations that may require a different level (e.g., a higher level) privilege.

The components for the communication adaptor 242 may be provided in a software development kit (SDK). The SDK can be downloaded and run on a user terminal or any appropriate computing device. The SDK may include a plurality of classes (containing code libraries) that provide access to the various functional modules. The code libraries may be available for free to users (e.g., developers). Alternatively, a developer may have to make a payment to a provider of the code libraries (or SDK) in order to access certain code libraries. In some instances, a developer may be required to comply with a set of usage guidelines when accessing and/or using the code libraries. The code libraries can include executable instructions for an application to access the various functional modules. A developer can develop an application by inputting codes (e.g., compilable or readily executable instructions) into a user terminal or computing device running the SDK. The input codes can reference the code libraries within the SDK. If the input codes contain compilable instructions, a compiler can compile the input codes into an application for the movable object. The application may be executed either directly onboard the movable object. Alternatively, the application may be executed on a user terminal in communication with (and that controls) the movable object.

Next, examples of different classes in the SDK are described as follows.

A drone class in the SDK may be an aggregation of a plurality of components for the UAV (or a drone). The drone class has access to the other components, can interchange information with the other components, and can control the other components. In some embodiments, an application may access only one instance of a drone class. Alternatively, an application may access multiple instances of a drone class.

In some embodiments, an application can connect to an instance of the drone class in order to upload controlling commands to the UAV. After connecting to the UAV, a user (e.g., an application developer) can have access to the other classes (e.g. the camera class and/or the gimbal class). The drone class can be subsequently used for invoking specific functions, e.g. the camera functions and the gimbal functions, to control the behavior of the UAV.

In some embodiments, an application can use a battery class for controlling the power source of a UAV. Also, the application can use the battery class for planning and testing the schedule for various flight tasks. Since battery power is critical to flight of a UAV, the application may determine the status of the battery, not only for the safety of the UAV but also for making sure that the UAV and/or its other functional modules have enough remaining power to complete certain designated tasks. For example, the battery class can be configured such that if the battery level is below a predetermined threshold, the UAV can terminate the current tasks and move to a safe or home position. Using the SDK, the application can obtain the current status and information of the battery at any time by invoking a get( ) function in the battery class. Also, the application can use a set( ) function for controlling a frequency of the battery status updates.

In some embodiments, an application can use a camera class for defining various operations on the camera in a movable object (such as a UAV). For example, the camera class may include functions for receiving media data in a Secure Digital (SD) card, obtaining & setting imaging parameters, taking photos, recording videos, etc. An application can also use the camera class for modifying the settings of photos. For example, a user can adjust the size of photos taken via the camera class. Also, an application can use a media class for maintaining the photos.

In some embodiments, an application can use a gimbal class for controlling a view from the UAV. For example, the gimbal class can be used for configuring an actual view, e.g. setting a first person view (FPV) from the UAV. Also, the gimbal class can be used for automatically stabilizing the gimbal, for example such that the gimbal is locked in one direction. Additionally, the application can use the gimbal class to change the angle of view for detecting different objects in a physical environment.

In some embodiments, an application can use a flight controller class for providing various flight control information and status about the UAV. Using the flight controller class, an application can monitor flight status, e.g. via instant messages. For example, a callback function in the flight controller class can send back instant messages to the application at a predetermined frequency (e.g. every one thousand milliseconds (1000 ms)).

In some embodiments, the flight controller class can allow a user of the application to analyze flight data contained in the instant messages received from the UAV. For example, a user (pilot) can analyze the data for each flight to further improve their proficiency in flying the UAV.

In some embodiments, an application can use a ground station class to perform a series of operations for controlling the UAV. For example, the SDK may require the application to have a key for using the ground station class. The ground station class can provide one-key-fly, on-key-go-home, manual control of the UAV (e.g., joystick mode), setting up a flight trajectory and/or waypoints, and various other task scheduling functionalities.

An application may be configured to control a movable object to perform one or more user-specified tasks. The user-specified tasks may comprise at least one of the following: agriculture operation, aerial imagery, intelligent navigation, live video feed, autonomous flight, data collection and analysis, parking inspection, distance measurement, visual tracking, and/or environmental sensing. The user-specified tasks may be performed using one or more functional modules of the movable object.

In some instances, a user who is remotely operating a movable object (e.g., a UAV) may wish to view an operational status of the UAV as an application is being executed. For example, the user may want to know whether the UAV is properly performing a designated task. Additionally, the user may want to know whether there are any issues (such as component malfunction) requiring the user's attention or intervention.

According to various embodiments of the disclosure, the operational status of a movable object can be provided by controlling the movable object to exhibit certain behaviors during task performance. For example, the movable object may be directed to behave in a predetermined manner when the movable object operates to perform one or more user-specified tasks. The predetermined manner may include a visual effect, an audio effect, or a motion effect, as described in detail later in the specification.

The operation of the movable object may be autonomous, semi-autonomous, or manually controlled by a user. In some embodiments, the movable object may be operated using a remote controller configured to receive a user input. The user input may be provided to the remote controller to activate an application that instructs the movable object to perform a specific task. The remote controller may be a user terminal as described elsewhere herein. The application may be provided on the remote controller (or on a user terminal, for example as shown in FIG. 1). In some other embodiments, the movable object may be autonomously operated using a flight controller onboard the movable object. The autonomous operation of the movable object may be controlled by an application provided onboard the movable object.

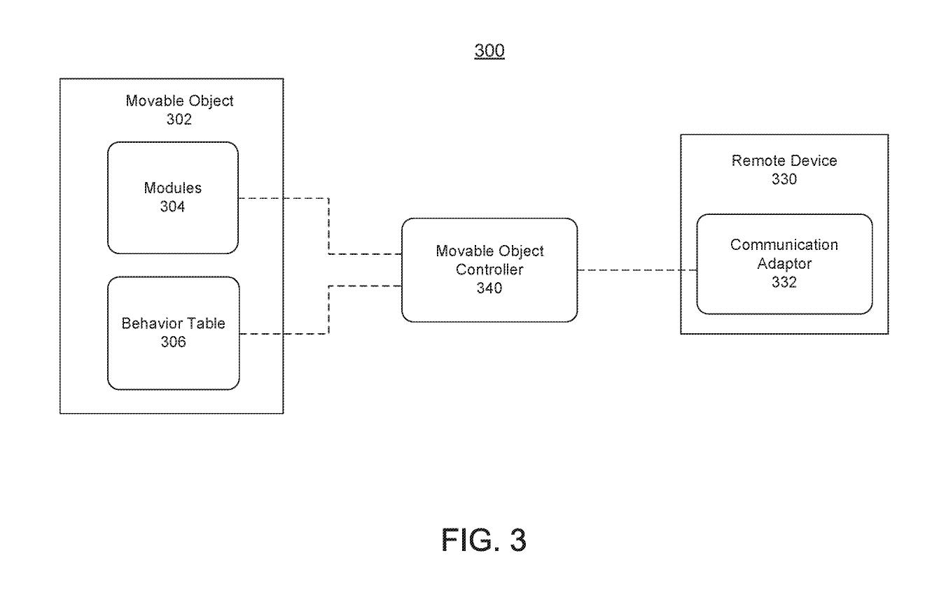

FIG. 3 illustrates a software development environment in which a movable object controller is configured to manage communication between a movable object and a remote device, in accordance with some embodiments. As shown in FIG. 3, a movable object 302, a remote device 330, and a movable object controller 340 may be provided in a software development environment 300. The device 330 may be located remotely from the movable object. The remote device may or may not be physically connected to the movable object. In some embodiments, the remote device may be a user terminal. For example, the remote device may be a mobile device, a personal computer (PC), a computer server, or a remote controller. In some embodiments, the remote device may be another movable object. The remote device 330 may include a communication adaptor 332 for providing access to the movable object controller 340, and through which the movable object controller receives data from the remote device. The communication adaptor can be based on, for example, an application programming interface (API) provided on the device. In some embodiments, the API may be an IOS™-based API or Android™-based API implemented on the device.

The movable object controller can communicate with the movable object and the remote device using one or more communication channels (e.g., wired and/or wireless) as described elsewhere herein. The movable object controller can allow the remote device to access the movable object, and transmit/receive data between the movable object and the remote device.

The movable object 302 may comprise functional modules 304 as described elsewhere herein. Additionally, the movable object 302 may comprise a behavior table 306. The behavior table may include a list of behaviors that the movable object exhibits when performing different user-specific tasks in various applications. The behaviors may be represented using one or more behavioral indicators. The behavioral indicators may define a behavior of the movable object in one or more predetermined manners. Examples of different behaviors having predetermined manners may include the movable object exhibiting a visual effect, an audio effect, and/or a motion effect.

A visual effect can be generated by driving one or more light-emitting elements onboard the movable object. The visual effect can be visually discernible to the naked eye. The visual effect may be visible to a user located remotely from the movable object. The light-emitting elements may include an LED, incandescent light, laser, or any type of light source. In some embodiments, the light-emitting elements may be configured to emit light of a same color (particular wavelength) or different colors (a combination of different wavelengths of light). The visual effect may also include light emission having any temporal pattern. For example, the visual effect may include a predetermined sequence of light flashes at a same time interval or at different time intervals. In some cases, the light-emitting elements may emit light towards a remote user, or towards a predetermined target. The predetermined target may be, for example a target that the movable object is configured to follow or track.

The visual effect may include light emitted in any spatial pattern. For example, the pattern may include a laser spot, or an array of laser spots. The laser can have modulated data. In some cases, the pattern may display an image, a symbol, or can be any combination of colored patterns. Each pattern may be visually distinguishable from the other.

An audio effect can be generated by driving one or more acoustic elements onboard the movable object. The audio effect may be audible to a user located remotely from the movable object. The acoustic elements may include speakers that are configured to emit sound of a same frequency or different frequencies. The audio effect may also include sound emissions having any temporal pattern. For example, the audio effect may comprise a predetermined sequence of sounds at a same time interval or different time intervals. In some embodiments, the speakers may be configured to emit sound signals in an omnidirectional manner. Alternatively, the speakers may emit sound signals primarily in a single direction, two directions, or any number of multiple directions. In some cases, the speakers may emit sound signals that are directed towards a remote user, or towards a predetermined target. The predetermined target may be, for example a target that the movable object is configured to follow or track.

The audio effect may dominate over background noise generated by the movable object. For example, an amplitude of the sound signals produced in the audio effect may be substantially greater than an amplitude of the background noise. The background noise may include sounds coming from the propellers, carrier, motors, camera, or any other noise-producing component of the movable object.

A motion effect can be generated by driving one or more propulsion units onboard the movable object to result in (1) a motion pattern of the movable object, or (2) movement of the movable object along a predetermined motion path. The motion effect of the movable object may be visually discernible to the naked eye. The motion effect may be visible to a user located remotely from the movable object.

The motion pattern of the movable object may include a rotation of the movable object about its pitch, roll, and/or yaw axes. For example, in some embodiments, the motion pattern may include a pitch motion, a roll motion, and/or a yaw motion of the movable object. The angle of pitch, roll, and/or yaw can be controlled by adjusting power to the propulsion units of the movable object via electronic speed control (ESC) units, and can be measured using an inertial measurement unit (IMU) onboard the movable object. The motion pattern may be effected while the movable object is hovering at a stationary spot, or moving in mid-air.

As described above, the motion effect can also include a movement of the movable object along a predetermined motion path. The motion path may be straight (linear), curved, or curvilinear. Points on the motion path may lie on a same plane or on different planes. Movement of the movable object along the motion path can be effected using a flight controller and propulsion units onboard the movable object. The motion path may be substantially fixed, or may be variable or dynamic. The motion path may include a heading in a target direction. The motion path may have a closed shape (e.g., a circle, ellipse, square, etc.) or an open shape (e.g., an arc, a U-shape, etc).

One or more behavioral indicators may be associated with one or more indicator codes. Each behavioral indicator may be associated with a unique indicator code. In some embodiments, a plurality of behavioral indicator may be associated with a unique indicator code. Alternatively, a single behavioral indicator may be associated with a plurality of indicator codes.

The indicator codes may be used to index the behavioral indicators. For example, each behavioral indicator may be indexed (“tagged”) with a unique indicator code. The behavioral indicators and corresponding indicator codes may comprise sets of instructions for directing the movable object to behave in one or more of the previously-described predetermined manners. The behavior table may be provided in the form of a look-up table comprising the behavioral indicators and the corresponding indicator codes. The indicator codes can provide quick access to the behavioral indicators in the behavior table. The behavior table may be registered on the movable object. For example, the behavior table may be stored in a memory unit that is accessible by (1) the movable object controller, and/or (2) other modules of the movable object. The behavior table may also be accessible by a remote device or an onboard device via the movable object controller. Optionally, the behavior table that is registered on one movable object may be accessible by another different movable object via the movable object controller.

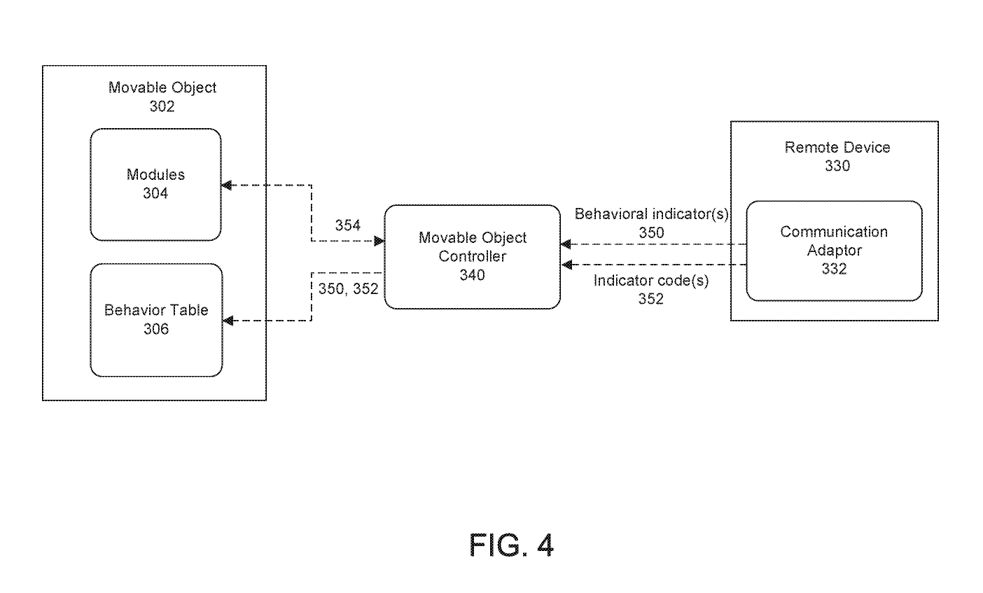

FIG. 4 illustrates the transmission of behavioral indicators and indicator codes from a remote device to a movable object, in accordance with some embodiments. The embodiment in FIG. 4 may be similar to the one shown in FIG. 3. In FIG. 4, the movable object controller 340 may receive a request from the remote device 330 to register one or more behavioral indicators for the movable object. The request may include behavioral indicator(s) 350 and indicator code(s) 352 that are being transmitted from the remote device. The behavioral indicator(s) 350 may be associated with the indicator code(s) 352 by the remote device, by the movable object controller, or by the movable object.

In some embodiments, one or more processors on the remote device may be configured to, individually or collectively, associate the behavioral indicator(s) with the indicator code(s) prior to transmitting the request to the movable object controller. The behavioral indicator(s) and associated indicator code(s) may be provided in a behavior table that is transmitted in the request from the remote device to the movable object controller.

In other embodiments, the movable object controller may be configured to associate the behavioral indicator(s) with the indicator code(s). The movable object controller may be configured to provide the behavioral indicator(s) and the indicator code(s) in a behavior table, and transmit the behavior table to the movable object, whereby the behavior table is to be stored in a memory unit onboard the movable object.

In some further embodiments, the movable object controller may be configured to transmit the behavioral indicator(s) and the indicator code(s) to the movable object. One or more processors onboard the movable object may be configured to, individually or collectively, associate the behavioral indicator(s) and the indicator code(s). The behavioral indicator(s) and associated indicator code(s) may be provided in a behavior table 306 that is registered on the movable object. For example, the behavior table 306 may be stored in a memory unit onboard the movable object.

As shown in FIG. 4, the movable object controller may be in two-way communication 354 with the modules in the movable object. In some embodiments, the movable object controller may be configured to determine, based on the hardware and/or firmware configuration of the modules, whether each of the behavioral indicator received from the remote device is executable by the movable object. For example, a behavioral indicator that requires an audio effect may not be executable if none of the modules in the movable object comprises a speaker that is capable of emitting sounds of a certain amplitude (decibel) and/or frequency. Likewise, in another example, a behavioral indicator that requires a motion effect may not be executable if the propulsion units, ESCs, and/or flight controller of the movable object are not capable of achieving the desired motion effect (e.g., a motion pattern or flight that exceeds the speed and/or maneuvering capability of the movable object).

In some embodiments, the movable object controller may be configured to determine which of the behavioral indicator(s) are executable by the movable object, and to associate the indicator code(s) with only those behavioral indicator(s) that are executable. The movable object controller may then selectively transmit those executable behavioral indicator(s) and associated indicator code(s) to the movable object.

In some alternative embodiments, the movable object controller may be configured to associate indicator code(s) with all of the received behavioral indicator(s), regardless whether the behavioral indicator(s) are executable by the movable object. The movable object controller may then transmit all of the behavioral indicator(s) and indicator code(s) to the movable object. During operation of the movable object, one or more processors onboard the movable object may make a determination as to which of the behavioral indicator(s) are executable, based on the hardware and/or firmware configuration of the modules, and to implement only those that are executable.

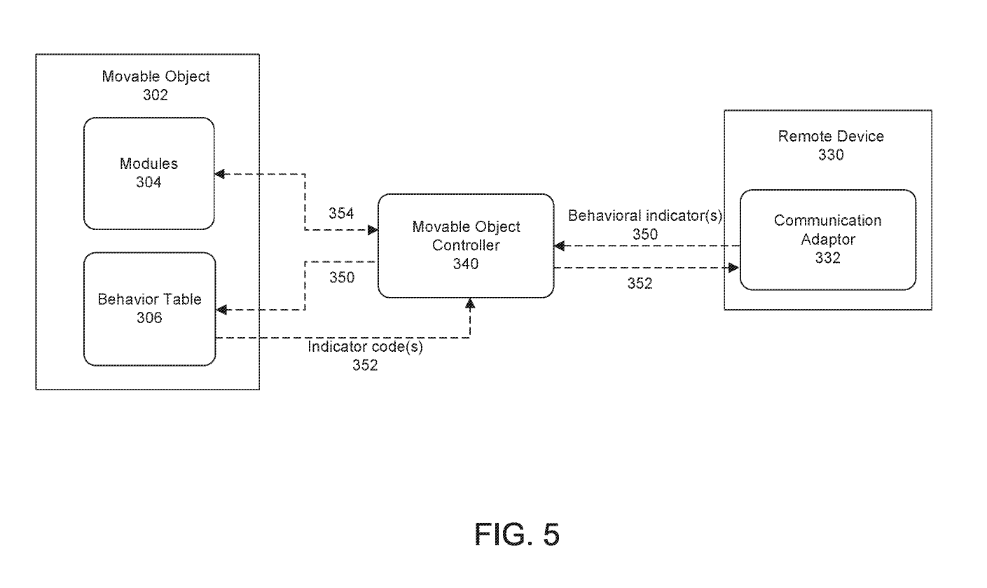

FIG. 5 illustrates the transmission of indicator codes from a movable object back to a remote device, in accordance with some other embodiments. In FIG. 5, the request from the remote device to the movable object controller may be to register the behavioral indicator(s) on the movable object. For example, the request may include only the behavioral indicator(s) 350.

In the example of FIG. 5, the behavioral indicator(s) 350 may be associated with indicator code(s) 352 on the movable object. The movable object controller may be configured to transmit the behavioral indicator(s) to the movable object. Next, one or more processors onboard the movable object may be configured to, individually or collectively, determine based on the hardware and/or firmware configuration of the modules, whether each of the behavioral indicators received from the remote device is executable by the movable object. The processor(s) onboard the movable object may be configured to obtain and associate indicator code(s) with only those behavioral indicator(s) that are executable. Alternatively, the movable object controller may be configured to determine, based on the hardware and/or firmware configuration of the modules, whether each of the behavioral indicators received from the remote device is executable by the movable object. Additionally, the movable object controller may be configured to obtain and associate indicator code(s) with only those behavioral indicator(s) that are executable.

In some alternative embodiments, the processor(s) onboard the movable object may be configured to obtain and associate indicator code(s) with all of the received behavioral indicator(s), regardless whether the behavioral indicator(s) are executable by the movable object. During operation of the movable object, the processor(s) onboard the movable object may make a determination as to which of the behavioral indicator(s) are executable, based on the hardware and/or firmware configuration of the modules, and to implement only those ones that are executable.

As shown in FIG. 5, the movable object may be configured to transmit the indicator code(s) 352 back to the remove device via the movable object controller. The indicator code(s) 352 and behavioral indicator(s) 350 may be provided in a behavior table (e.g., a copy of behavior table 306) that is stored in a memory unit on the remote device.

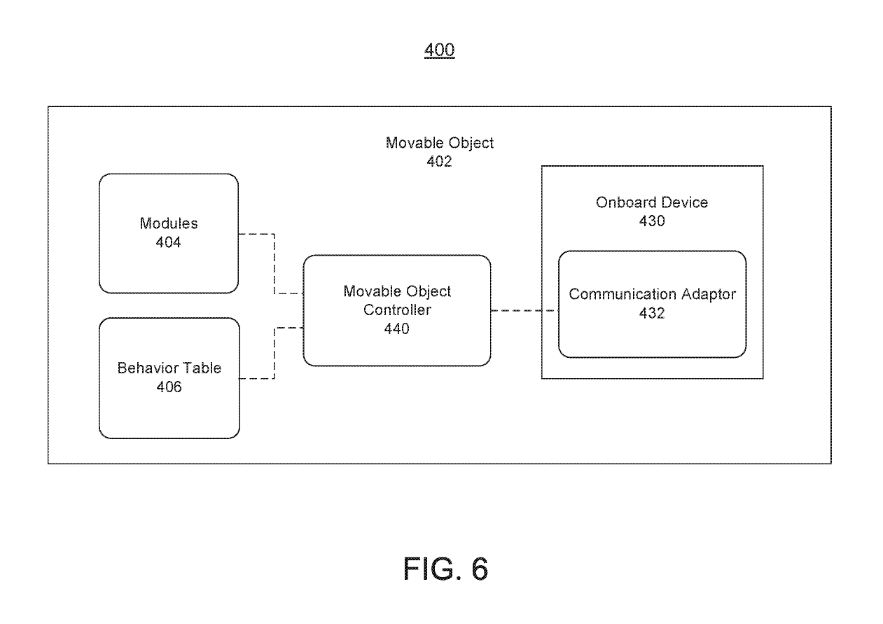

FIG. 6 illustrates a software development environment in which a movable object controller is configured to manage communication between a movable object and an onboard device to register a behavior table, in accordance with some embodiments. The embodiment of FIG. 6 is similar to the embodiment of FIG. 3 except for the following difference. In FIG. 6, all of the depicted components may be located onboard the movable object.

As shown in FIG. 6, a movable object 402 may be provided in a software development environment 400. A device 430 may be located onboard the movable object. For example, the onboard device 430 may be located within a housing or a central body of the movable object. The onboard device may be a computing device with a computer chip, for example an application-specific IC (ASIC), programmable logic device (PLD), field-programmable gate array (FPGA), etc. In some embodiments, the onboard device may be operably coupled to and removable from the movable object. For example, the onboard device may be attached via one or more connectors to a central circuit board located within the movable object. The onboard device 430 may include a communication adaptor 432 for providing access to a movable object controller 440. The movable object controller may be provided onboard the movable object. Alternatively, the movable object controller may be remote from the movable object. For example, the movable object controller may be provided on a user terminal in communication with the movable object. The movable object controller may be configured to manage communications between the onboard device 430 and various functional modules 404 located onboard the movable object. The communications may include wired and/or wireless communications as described elsewhere herein. The movable object controller can allow the onboard device to access the modules on the movable object.

The movable object 402 may comprise a behavior table 406. The behavior table may include a list of behaviors that the movable object exhibits when performing different user-specific tasks in various applications. The behavior(s) may be represented using one or more behavioral indicators. The behavioral indicator(s) may be configured to define or control behavior of the movable object in one or more predetermined manners. The behaviors in the predetermined manners may include the movable object exhibiting a visual effect, an audio effect, and/or a motion effect, as described elsewhere herein.

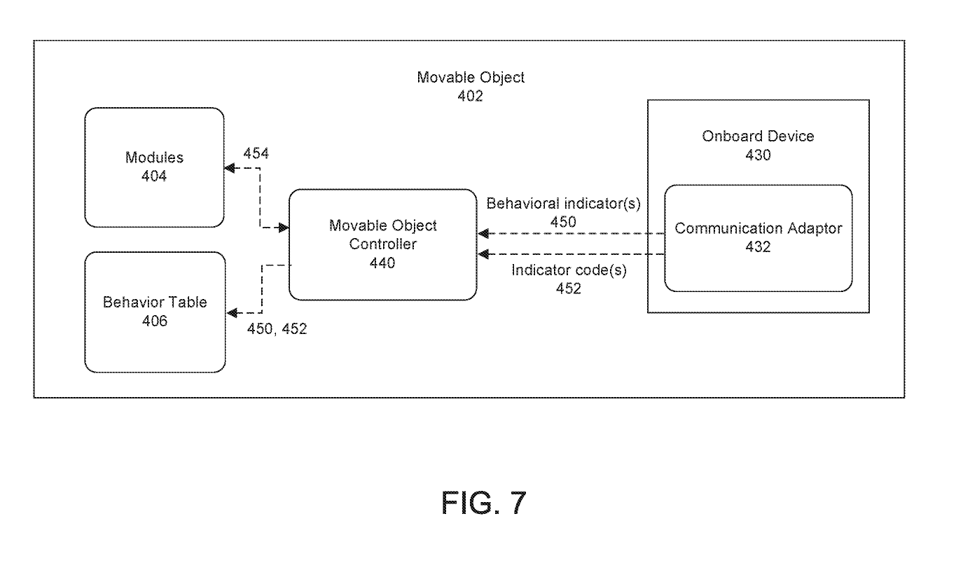

FIG. 7 illustrates the generation of a behavior table onboard a movable object, in accordance with some embodiments. The embodiment in FIG. 7 may be similar to the one shown in FIG. 6. In FIG. 7, the movable object controller 440 may receive a request from the onboard device 430 to register one or more behavioral indicators for the movable object. The request may include behavioral indicator(s) 450 and indicator code(s) 452 that are being transmitted from the onboard device. The behavioral indicator(s) 450 may be associated with the indicator code(s) 452 by the onboard device, by the movable object controller, or by one or more processors onboard the movable object.

In some embodiments, the onboard device may be configured to, individually or collectively, associate the behavioral indicator(s) with the indicator code(s) prior to transmitting the request to the movable object controller. The behavioral indicator(s) and associated indicator code(s) may be provided in a behavior table that is transmitted in the request from the onboard device to the movable object controller.

In other embodiments, the movable object controller may be configured to associate the behavioral indicator(s) with the indicator code(s). The movable object controller may be configured to provide the behavioral indicator(s) and the indicator code(s) in a behavior table 406, and store the behavior table in a memory unit onboard the movable object.

In some further embodiments, the movable object controller may be configured to transmit the behavioral indicator(s) and the indicator code(s) to one or more processors onboard the movable object. The processor(s) onboard the movable object may be configured to, individually or collectively, associate the behavioral indicator(s) and the indicator code(s). The behavioral indicator(s) and associated indicator code(s) may be provided in a behavior table 406 that is registered on the movable object. For example, the behavior table 406 may be stored in a memory unit onboard the movable object.

As shown in FIG. 7, the movable object controller may be in two-way communication 454 with the modules in the movable object. The movable object controller may be configured to determine, based on the hardware and/or firmware configuration of the modules, whether each of the behavioral indicator received from the onboard device is executable by the movable object. For example, a behavioral indicator that requires an audio effect may not be executable if none of the modules in the movable object comprises a speaker that is capable of emitting sounds of a certain amplitude (decibel) and/or frequency. Likewise, in another example, a behavioral indicator that requires a motion effect may not be executable if the propulsion units, ESCs, and/or flight controller of the movable object are not capable of achieving the desired motion effect (e.g., a motion pattern or flight that exceeds the speed and/or maneuvering capability of the movable object).

In some embodiments, the movable object controller may be configured to determine which of the behavioral indicator(s) are executable by the movable object, and to associate the indicator code(s) with only those behavioral indicator(s) that are executable. The movable object controller may then selectively store those executable behavioral indicator(s) and associated indicator code(s) in a memory unit onboard the movable object.

In some alternative embodiments, the movable object controller may be configured to associate indicator code(s) with all of the received behavioral indicator(s), regardless whether the behavioral indicator(s) are executable by the movable object. The movable object controller may then store all of the behavioral indicator(s) and indicator code(s) in a memory unit onboard the movable object. During operation of the movable object, one or more processors onboard the movable object may make a determination as to which of the behavioral indicator(s) are executable, based on the hardware and/or firmware configuration of the modules, and to implement only those that are executable.

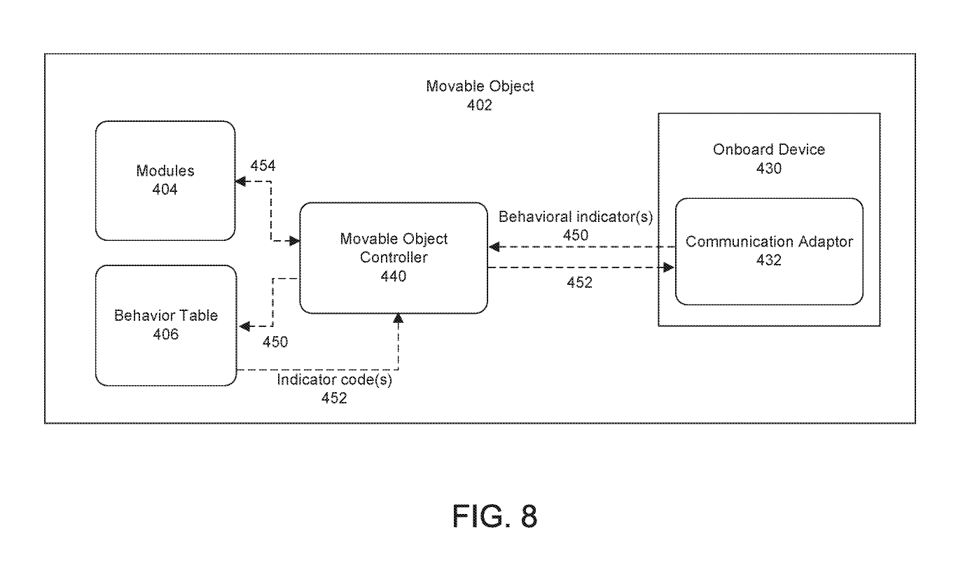

FIG. 8 illustrates the transmission of indicator codes back to an onboard device, in accordance with some other embodiments. The embodiment in FIG. 8 may be similar to the one shown in FIG. 7 except for the following difference. In FIG. 8, the request from the onboard device 430 to the movable object controller 440 may include only the behavioral indicator(s) 450. The request may be to register the behavioral indicator(s) and obtain indicator code(s) on the movable object. The behavioral indicator(s) 450 may be associated with the indicator code(s) 452 by the movable object controller, or by one or more processors onboard the movable object. As shown in FIG. 8, the processor(s) onboard the movable object may be configured to transmit the indicator code(s) 452 back to the onboard device via the movable object controller.

In the example of FIG. 8, the behavioral indicator(s) 450 may be associated with indicator code(s) 452 using one or more processors onboard the movable object 402. The movable object controller 440 may be configured to transmit the behavioral indicator(s) to the one or more processors. The processor(s) onboard the movable object may be configured to, individually or collectively, determine based on the hardware and/or firmware configuration of the functional modules 404, whether each of the behavioral indicators received from the onboard device is executable by the movable object. The processor(s) onboard the movable object may be configured to obtain and associate indicator code(s) with only those behavioral indicator(s) that are executable.

In some alternative embodiments, the processor(s) onboard the movable object 402 may be configured to obtain and associate indicator code(s) with all of the received behavioral indicator(s), regardless whether the behavioral indicator(s) are executable by the movable object. During operation of the movable object, the processor(s) onboard the movable object may make a determination as to which of the behavioral indicator(s) are executable, based on the hardware and/or firmware configuration of the modules, and to implement only those ones that are executable.

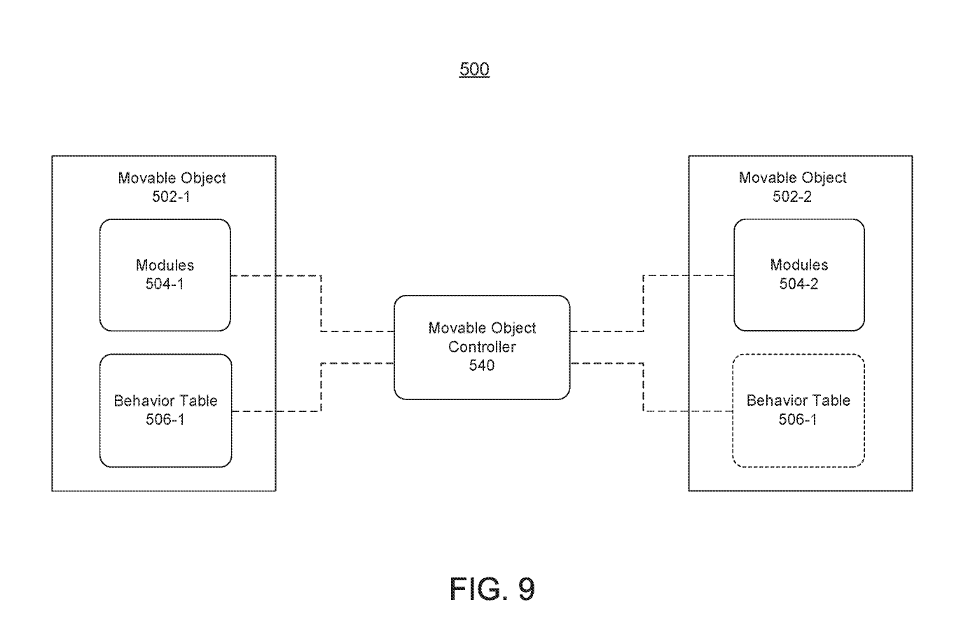

FIG. 9 illustrates a software development environment in which a movable object controller is configured to manage communication between different movable objects to register a behavior table, in accordance with some embodiments.

As shown in FIG. 9, a plurality of movable objects 502 (e.g., a first movable object 502-1 and a second movable object 502-2) may be provided in a software development environment 500. A movable object controller 540 may be provided to handle communications between the movable objects. The movable object controller may be provided onboard the movable objects, or remote from the movable objects. For example, in some instances, the movable object controller may be provided on a user terminal in communication with the movable objects. The movable object controller may be configured to manage communications between functional modules 504 located onboard the movable objects. For example, the first movable object 504-1 may comprise a first set of functional modules 504-1, and the second movable object 504-2 may comprise a second set of functional modules 504-2. The communications between the movable objects may include wired and/or wireless communications as described elsewhere herein. In some embodiments, the movable object controller can allow the first movable object to access the second set of modules that are located on the second movable object. Additionally, the movable object controller can allow the second movable object to access the first set of modules that are located on the first movable object. In some embodiments, the movable object controller may be in communication with a communication adaptor located on one or more devices (external or onboard). In some cases, the one or more devices may include one or more user terminals that are used to control a plurality of movable objects.

In some embodiments, a plurality of movable objects may be in communication with one another via a mesh network. Each movable object may be represented individually by a node in the mesh network. The nodes are interconnected with other nodes in the mesh network so that multiple pathways connect each node. Connections between nodes can be dynamically updated and optimized using built-in mesh routing tables. Mesh networks may be decentralized in nature, and each node may be capable of self-discovery on the network. Also, as nodes leave the network, the mesh topology allows the nodes to reconfigure routing paths based on the new network structure. The characteristics of mesh topology and ad-hoc routing provide greater stability in changing conditions or failure at single nodes. For example, when one or more movable objects leave the network, the remaining movable objects can reconfigure new routing paths (or physical flight/motion paths) based on the new network structure. In some embodiments, the network may be a full mesh network where all of the movable objects are meshed and in communication with one another. In other embodiments, the network may be a partial mesh network where only some of the movable objects are meshed and in communication with one another.

The mesh network may be supported by a wireless protocol that can enable broad-based deployment of wireless networks with low-cost, low-power solutions. The protocol may allow communication of data through various radio frequency (RF) environments in both commercial and industrial applications. The protocol can allow the movable objects to communicate in a variety of network topologies. The protocol may include features such as: (1) support for multiple network topologies such as point-to-point; (2) point-to-multipoint and mesh networks; (3) low duty cycle to extend battery life; (4) low latency for lower power consumption; (5) Direct Sequence Spread Spectrum (DSSS); (6) up to 65,000 nodes per network; (7) 128-bit AES encryption for secure data connections; and (8) collision avoidance and retries. The low duty cycle can enable the movable objects to be operated for a longer period of time, since less power is consumed during the low duty cycle. The high number of nodes (up to 65,000 nodes) allowable in the network can enable a large number of movable objects to be connected and controlled within the mesh network.

In some instances, the protocol can provide an easy-to-use wireless data solution that is characterized by secure, reliable wireless network architectures. The protocol can be configured to meet the needs of low-cost, low-power wireless machine-to-machine (M2M) networks. Examples of such machines may include the movable objects. The protocol may be configured to provide high data throughput in applications where the duty cycle is low and low power consumption is an important consideration. For example, some or all of the movable objects may be powered by batteries, whereby low power consumption is desirable to increase flight time/distance or motion time/distance.

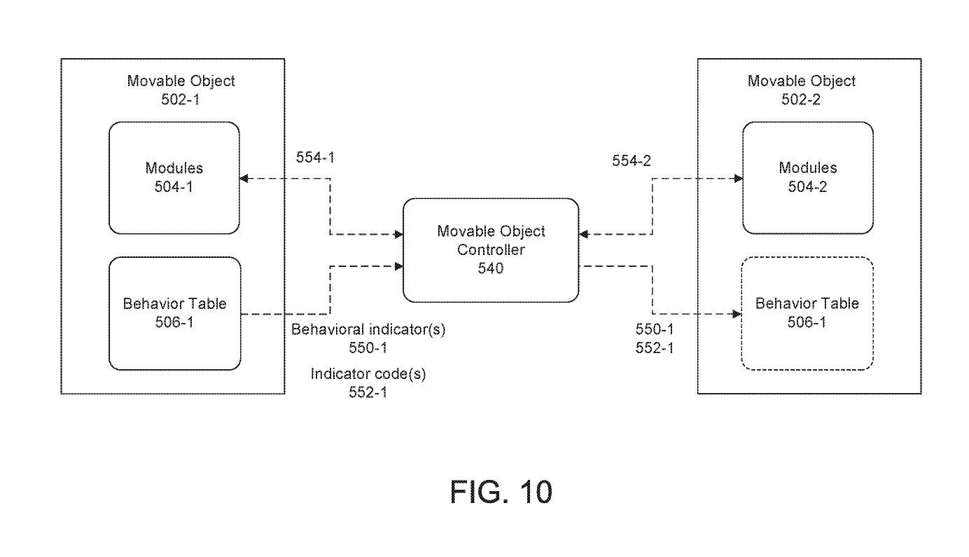

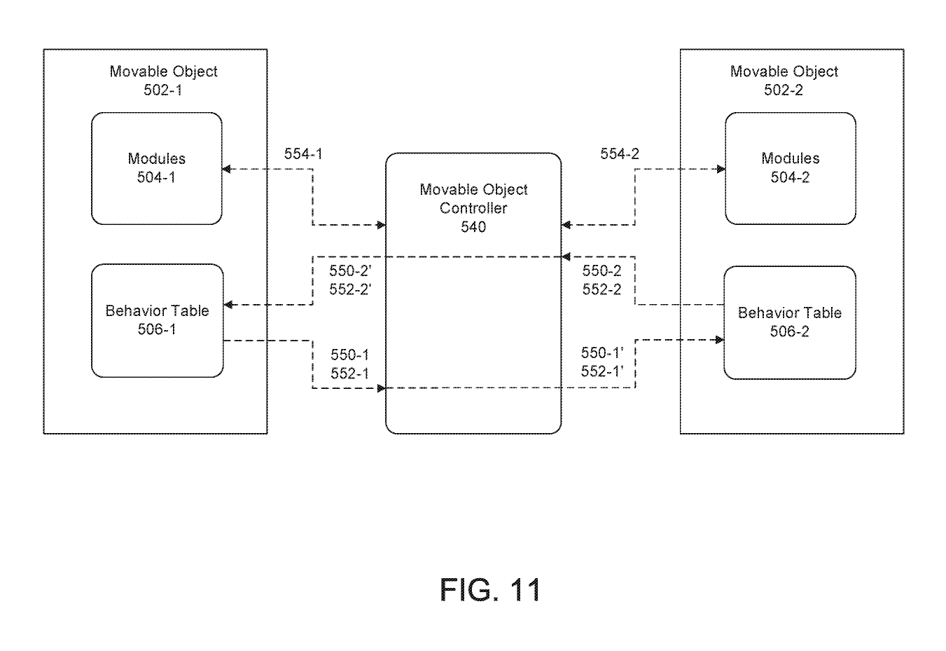

As shown in FIG. 9. the first movable object 502-1 may comprise a first behavior table 506-1. The first behavior table may include a list of behaviors that the first movable object exhibits when performing different user-specific tasks in various applications. The behavior(s) may be represented using one or more behavioral indicators. The behavioral indicator(s) may be configured to define or control behavior of the first movable object in one or more predetermined manners. The behaviors in the predetermined manners may include the movable object exhibiting a visual effect, an audio effect, and/or a motion effect, as described elsewhere herein. The behavior table for one movable object may be registered onto another movable object via the movable object controller, as described below with reference to FIGS. 10 and 11.

FIG. 10 illustrates one-way registration of a behavior table from one movable object to another movable object, in accordance with some embodiments. The embodiment in FIG. 10 may be similar to the one shown in FIG. 9. In FIG. 10, a movable object controller 540 may receive a request to register a first behavior table 506-1 (for the first movable object 502-1) onto a second movable object 502-2. The first behavior table may be pre-registered on the first movable object. The first behavior table may comprise behavioral indicator(s) 550-1 and associated indicator code(s) 552-1. The request to register the first behavior table onto the second movable object may come from one or more sources. For example, the request may come from a remote device (which may be a user terminal or remote controller), from the first movable object, from the second movable object, or from another different movable object.

As shown in FIG. 10, the movable object controller may be configured to obtain the first behavior table from the first movable object, and to transmit the first behavior table to the second movable object. The first behavior table may be stored in a memory unit onboard the second movable object.

The movable object controller may be in two-way communication 554 with the modules in each of the first and second movable objects. The movable object controller may be configured to determine, based on the hardware and/or firmware configuration of the modules in the second movable object, whether each of the behavioral indicators in the first behavior table is executable by the second movable object. For example, a behavioral indicator that requires an audio effect may not be executable by the second movable object if none of the modules in the second movable object comprises a speaker that is capable of emitting sounds of a certain amplitude (decibel) and/or frequency. Likewise, in another example, a behavioral indicator that requires a motion effect may not be executable by the second movable object if the propulsion units, ESCs, and/or flight controller of the second movable object are not capable of achieving the desired motion effect (e.g., a motion pattern or flight that exceeds the speed and/or maneuvering capability of the second movable object).

In some embodiments, the movable object controller may be configured to determine which of the behavioral indicator(s) from the first movable object are executable by the second movable object, and to transmit only the executable behavioral indicator(s) and indicator code(s) to the second movable object.

In some alternative embodiments, the movable object controller may be configured to transmit the entire first behavior table to the second movable object, regardless whether one or more of the behavioral indicator(s) are executable by the second movable object. During operation of the second movable object, one or more processors onboard the second movable object may make a determination as to which of the behavioral indicator(s) are executable, based on the hardware and/or firmware configuration of the modules in the second movable object, and to implement only those that are executable.

FIG. 11 illustrates two-way registration of behavior tables from one movable object to another movable object, in accordance with some embodiments. A movable object controller 540 may receive a request to register a first behavior table 506-1 (for the first movable object 502-1) on a second movable object 502-2. Likewise, the movable object controller 540 may receive a request to register a second behavior table 506-2 (for the second movable object 502-2) on the first movable object 502-1. The first behavior table may be pre-registered on the first movable object, and the second behavior table may be pre-registered on the second movable object. The first behavior table may comprise behavioral indicator(s) 550-1 and associated indicator code(s) 552-1. The first behavior table may comprise behavioral indicator(s) 550-2 and associated indicator code(s) 552-2. The requests to register the behavior tables between the movable objects may come from one or more sources. For example, the requests may come from a remote device (which may be a user terminal or remote controller), from the first movable object, from the second movable object, or from another different movable object.

As shown in FIG. 11, the movable object controller may be configured to obtain the first behavior table from the first movable object, and the second behavior table from the second movable object. The movable object controller may be configured to update the first behavior table 506-1 to include behavioral indicator(s) 550-2′ and indicator code(s) 552-2′ that are missing from the first behavior table, but present in the second behavior table 506-2. Similarly, the movable object controller may be configured to update the second behavior table 506-2 to include behavioral indicator(s) 550-1′ and indicator code(s) 552-1′ that are missing from the second behavior table, but present in the first behavior table 506-1. Accordingly, the first and second movable objects can be configured to exchange behavioral indicator(s) and indicator code(s) via the movable object controller. In some instances, the first and behavior tables may be updated to include a larger set of behavioral indicator(s) and indicator code(s) after the movable object controller has processed the two-way registration requests.

The movable object controller may be in two-way communication 554 with the modules in each of the first and second movable objects. For example, the movable object controller may be in two-way communication 554-1 with functional modules 504-1 in the first movable object, and two-way communication 554-2 with functional modules 504-2 in the second movable object.

The movable object controller may be configured to determine, based on the hardware and/or firmware configuration of the modules in the second movable object, whether each of the behavioral indicator in the first behavior table is executable by the second movable object. Similarly, the movable object controller may be configured to determine, based on the hardware and/or firmware configuration of the modules in the first movable object, whether each of the behavioral indicator in the second behavior table is executable by the first movable object. The movable object controller may be configured to update the first behavior table to include only those behavioral indicator(s) and indicator code(s) from the second behavior table that are executable by the first movable object. Likewise, the movable object controller may be configured to update the second behavior table to include only those behavioral indicator(s) and indicator code(s) from the first behavior table that are executable by the second movable object.

In some embodiments, the movable object controller may be configured to register the entire second behavior table onto the first movable object, regardless whether one or more of the behavioral indicator(s) in the second behavior table are executable by the first movable object. During operation of the first movable object, one or more processors onboard the first movable object may make a determination as to which of the behavioral indicator(s) from the second behavior table are executable, based on the hardware and/or firmware configuration of the modules in the first movable object, and to implement only those that are executable.

In some embodiments, the movable object controller may be configured to register the entire first behavior table onto the second movable object, regardless whether one or more of the behavioral indicator(s) in the first behavior table are executable by the second movable object. During operation of the second movable object, one or more processors onboard the second movable object may make a determination as to which of the behavioral indicator(s) from the first behavior table are executable, based on the hardware and/or firmware configuration of the modules in the second movable object, and to implement only those that are executable.

One or more behavior tables can be used to effect different behaviors of multiple movable objects. For example, one or more behavior tables can be used to control the behavior of one movable object relative to another movable object. Alternatively, one or more behavior tables can be used to control the behaviors of a plurality of movable objects relative to another. For example, the plurality of movable objects may be controlled to move in a predetermined pattern, formation, and/or collaborate with one another to complete certain tasks. The predetermined pattern may include a parallel formation or a non-parallel formation in 3-dimensional space. In some embodiments, a relay or a peer-to-peer protocol may be used to communicate positioning information among the plurality of movable objects.

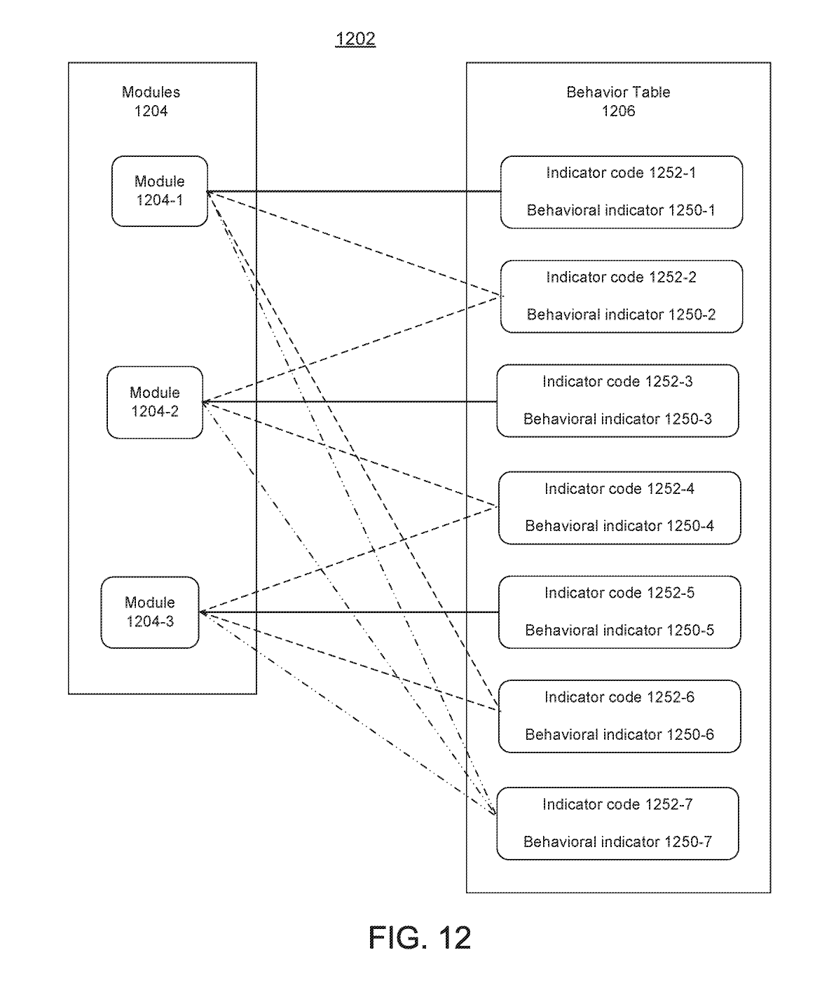

The behaviors of a movable object can be generated and/or effected using one or more modules of the movable object, as shown in FIG. 12. A movable object 1202 may include functional modules 1204 and a behavior table 1206. The movable object may include any number of modules 1204. For example, in some cases, the modules may comprise a first module 1204-1, a second module 1204-2, and a third module 1204-3. In some embodiments, the first module may be a light-emitting module, the second module may be a sound-emitting module, and the third module may be a flight controller module. The light-emitting module may comprise one or more light-emitting elements onboard the movable object that can be used to generate a visual effect. The sound-emitting module may comprise one or more acoustic elements onboard the movable object that can be used to generate an audio effect. The flight controller module may comprise a flight controller that can be used to drive one or more propulsion units onboard the movable object to generate a motion effect. The motion effect may include (1) a motion pattern of the movable object, or (2) movement of the movable object along a predetermined motion path.

As shown in FIG. 12, a behavior table 1206 may be registered on the movable object 1202. The behavior table may be stored in a memory unit onboard the movable object. The behavior table may comprise a plurality of behavioral indicators 1250 and associated indicator codes 1252. Any number of behavioral indicators and indicator codes may be contemplated. For example, the behavior table may comprise a first indicator code 1252-1 associated with a first behavioral indicator 1250-1, a second indicator code 1252-2 associated with a second behavioral indicator 1250-2, a third indicator code 1252-3 associated with a third behavioral indicator 1250-3, a fourth indicator code 1252-4 associated with a fourth behavioral indicator 1250-4, a fifth indicator code 1252-5 associated with a fifth behavioral indicator 1250-5, a sixth indicator code 1252-6 associated with a sixth behavioral indicator 1250-6, and a seventh indicator code 1252-7 associated with a seventh behavioral indicator 1250-7.

The behavioral indicators 1250 and corresponding indicator codes 1252 may comprise sets of instructions for directing the movable object 1202 to behave in a plurality of different predetermined manners, by using one or more of the modules 1204. In the example of FIG. 12, the first indicator code 1252-1 and behavioral indicator 1250-1 may be associated with a visual effect that can be generated using the first module 1204-1 (light-emitting module). The third indicator code 1252-3 and behavioral indicator 1250-3 may be associated with an audio effect that can be generated using the second module 1204-2 (sound-emitting module). The fifth indicator code 1252-5 and behavioral indicator 1250-5 may be associated with a motion effect that can be generated using the third module 1204-3 (flight controller module).

The movable object can also be directed to behave in a combination of different predetermined manners, using two or more modules 1204. For example, as shown in FIG. 12, the second indicator code 1252-2 and behavioral indicator 1250-2 may be associated with visual and audio effects that can be generated using the first module 1204-1 (light-emitting module) and second module 1204-2 (sound-emitting module). Similarly, the fourth indicator code 1252-4 and behavioral indicator 1250-4 may be associated with audio and motion effects that can be generated using the second module 1204-2 (sound-emitting module) and third module 1204-3 (flight controller module). Likewise, the sixth indicator code 1252-6 and behavioral indicator 1250-6 may be associated with visual and motion effects that can be generated using the first module 1204-1 (light-emitting module) and third module 1204-3 (flight controller module). The seventh indicator code 1252-7 and behavioral indicator 1250-7 may be associated with visual, audio, and motion effects that can be generated using the first module 1204-1 (light-emitting module), second module 1204-2 (sound-emitting module), and third module 1204-3 (flight controller module). Accordingly, a behavior table can comprise a variety of different behaviors (effects) using different combinations of the modules in the movable object.

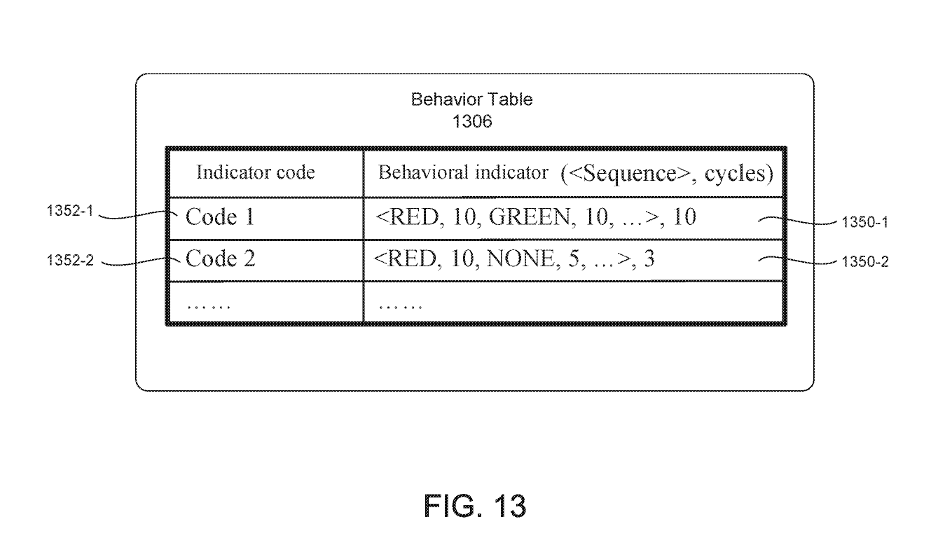

FIG. 13 illustrates a behavior table in accordance with some embodiments. A behavior table 1306 may comprise a plurality of indicator codes and behavioral indicators. In FIG. 13, the indicator codes and behavioral indicators may be associated with a visual effect that can be generated using a light-emitting module onboard the movable object. The light-emitting module may include light-emitting elements that are configured to emit light of different colors. For example, the light-emitting elements may include a red LED and a green LED. The visual effect may include light emission having any temporal pattern. For example, the visual effect may include a predetermined sequence of light flashes, of a same color or different colors, at a same time interval or at different time intervals.

As shown in FIG. 13, a first indicator code 1352-1 (“Code 1”) may be associated with a first behavioral indicator 1350-1. The first behavioral indicator may include turning on a red LED for 10 seconds, and then turning on a green LED for 10 seconds. At the end of the 20 seconds, the red and green LEDs may be turned off, and the above sequence for turning on/off the LEDs may be repeated for a total of 10 cycles. Similarly, a second indicator code 1352-2 (“Code 2”) may be associated with a second behavioral indicator 1350-2. The second behavioral indicator may include turning on a red LED for 10 seconds, turning off the red LED for 5 seconds, and repeating the above sequence for a total of 3 cycles. In some embodiments, the first behavioral indicator can be used to indicate to a user that a movable object has successfully performed a task, and the second behavioral indicator can be used to indicate to the user that a movable object has failed to perform the task. In some other embodiments, a third behavioral indicator (not shown) comprising another different lighting sequence can be used to indicate to a user about malfunction of a component onboard the movable object. In some further embodiments, a fourth behavioral indicator (not shown) comprising another different lighting sequence can be used to indicate to a user that a state of battery charge (remaining power level) of the movable object is below a predetermined threshold. Any number of behavioral indicators and uses for the behavioral indicators may be contemplated, thus allowing developers to creatively develop and use behavioral indicators in various applications.

In some embodiments, a method for controlling a movable object may be provided. The method may comprise receiving, via a movable object manager on a device in operable communication with the movable object, one or more control signals for the movable object. The method may also comprise obtaining, with aid of one or more processors individually or collectively, one or more indicator codes associated with the one or more control signals. The method may further comprise directing the movable object to behave based on the one or more indicator codes. The indicator codes may be pre-registered on the device and/or on the movable object. The device may be located remotely from or onboard the movable object.

In some instances, the indicator codes may be provided with the control signals to the device. The indicator codes may be associated with the control signals using one or more processors located on the device. The device may be configured to transmit the indicator codes and associated control signals to the movable object. Alternatively, the indicator codes may be associated with the control signals using one or more processors located on the movable object, after the movable object has received the control signals from the device.

In some embodiments, the movable object may be directed to behave in one or more predetermined manners when a user provides an input to a remote controller to activate one or more of the indicator codes (and the corresponding behavioral indicators). The input may comprise one or more control signals. The behavior of the movable object in the predetermined manners may include the movable object exhibiting a visual effect, an audio effect, and/or a motion effect.

The movable object may be directed to behave in one or more predetermined manners when the movable object operates to perform one or more user-specified tasks. The user-specified tasks may comprise at least one of the following: agriculture operation, aerial imagery, intelligent navigation, live video feed, autonomous flight, data collection and analysis, parking inspection, distance measurement, visual tracking, and/or environmental sensing. The user-specified tasks may be performed using one or more functional modules (e.g., camera, gimbal, sensors, etc.) of the movable object.

The operation of the movable object may be autonomous, semi-autonomous, or manually controlled by the user. In some embodiments, the movable object may be operated using a remote controller configured to receive a user input. The user input may be provided to the remote controller to activate an application that instructs the movable object to perform a specific task. The remote controller may be a user terminal as described elsewhere herein. The application may be provided on the remote controller (or on a user terminal, for example as shown in FIG. 1). In some other embodiments, the movable object may be autonomously operated using a flight controller onboard the movable object. The autonomous operation of the movable object may be controlled by an application provided onboard the movable object.

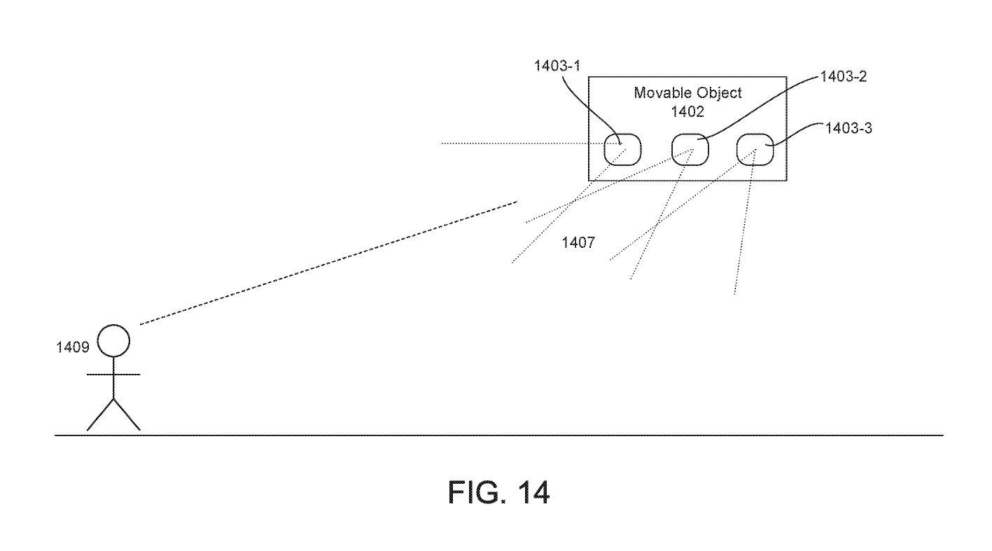

FIG. 14 illustrates a movable object displaying a visual effect to a remote user as the movable object is performing one or more tasks, in accordance with some embodiments. For example, an application may be configured to control a movable object 1402 to perform one or more user-specified tasks. The application may be provided on a device that is remote from or onboard the movable object.

In some instances, a user 1409 who is remotely operating the movable object 1402 (e.g., a UAV) may wish to view an operational status of the UAV as an application is being executed. For example, the user may want to know whether the UAV is properly performing a designated task. Additionally, the user may want to know whether there are any issues (such as component malfunction) requiring the user's attention or intervention.

In FIG. 14, the operational status of the movable object may be visible to the user. This can be achieved by controlling the movable object to display a visual effect 1407 when the movable object is being operated to perform one or more user-specified tasks. The movable object can be controlled via one or more control signals (previously described in FIG. 13) and the corresponding indicator codes. The control signals and indicator codes may comprise sets of instructions for directing the movable object to behave to display the visual effect 1407.

The visual effect 1407 can be generated by driving one or more light-emitting elements 1403 onboard the movable object. The light-emitting elements may form part of a light-emitting module onboard the movable object. The visual effect 1407 may be visually discernible to the user. The light-emitting elements may include an LED, incandescent light, laser, or any type of light source. In some embodiments, the light-emitting elements may be configured to emit light of a same color or different colors. For example, in some embodiments, a first light-emitting element 1403-1 may be a red LED, a second light-emitting element 1403-2 may be a green LED, and a third light-emitting element 1403-3 may be a blue LED. Any color of emitted light may be contemplated. The visual effect may include light emission having any temporal pattern. For example, the visual effect may include a predetermined sequence of light flashes, of a same color or different colors, at a same time interval or at different time intervals, as previously described in FIG. 13. In some cases, the LEDs may be configured to emit light towards the user, or towards a predetermined target. The predetermined target may be, for example a target that the movable object is configured to follow or track.

The visual effect may also include light emitted in any spatial pattern (not shown). For example, the pattern may include a laser spot, or an array of laser spots. The laser can have modulated data. In some cases, the pattern may display an image, a symbol, or can be any combination of colored patterns. Each pattern may be visually distinguishable from the other.

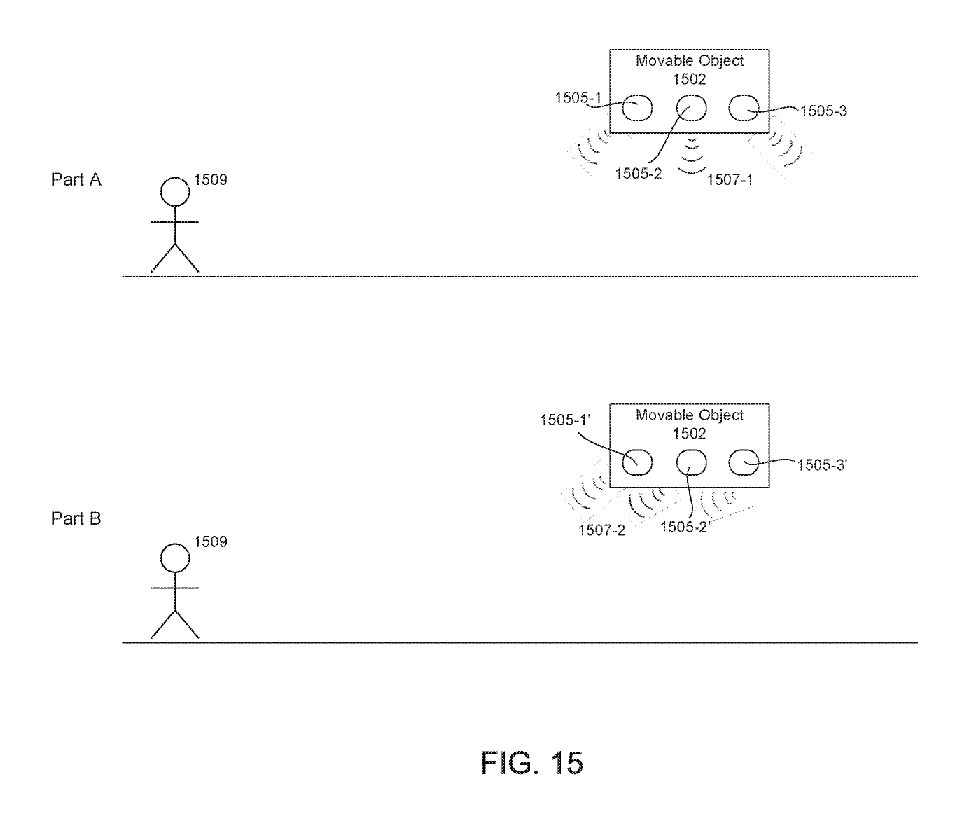

FIG. 15 illustrates a movable object generating an audio effect to a remote user as the movable object is performing one or more tasks, in accordance with some embodiments. For example, an application may be configured to control a movable object 1502 to perform one or more user-specified tasks. The embodiment of FIG. 15 may be similar to the one in FIG. 14, except the movable object 1502 is configured to generate an audio effect instead of a visual effect.

In the example of FIG. 15, the operational status of the movable object 1502 can be conveyed to a remote user 1509 through the use of sounds. This can be achieved by controlling the movable object to generate an audio effect 1507 when the movable object is being operated to perform one or more user-specified tasks. The movable object can be controlled via one or more control signals (previously described in FIG. 13) and the corresponding indicator codes. The control signals and indicator codes may comprise sets of instructions for directing the movable object to behave to generate the audio effect 1507.

The audio effect 1507 can be generated by driving one or more acoustic elements 1505 onboard the movable object. The audio effect may be audible to the remote user 1509. The acoustic elements may include speakers that are configured to emit sound of a same frequency or different frequencies. Any number of sound-emitting elements (or speakers) may be contemplated. The audio effect may also include sound emissions having any temporal pattern. For example, the audio effect may comprise a predetermined sequence of sounds at a same time interval or different time intervals. In some embodiments, a plurality of speakers (e.g., 1505-1, 1505-2, and 1505-3) may be configured to emit sound signals in an omnidirectional manner, for example as shown by audio effect 1507-1 in part A of FIG. 15. Alternatively, a plurality of speakers (e.g., 1505-1′, 1505-2′, and 1505-3′) may emit sound signals primarily in a single direction, for example as shown by audio effect 1507-2 in part B of FIG. 15. The speakers may be configured to emit sound signals in two directions, or any number of multiple directions. In some cases, the speakers may emit sound signals that are directed towards a remote user, for example as shown in part B of FIG. 15. Alternatively, the speakers may emit sound signals that are directed towards a predetermined target. The predetermined target may be, for example a target that the movable object is configured to follow or track.

The audio effect may dominate over background noise generated by the movable object. For example, an amplitude of the sound signals produced by the audio effect may be substantially greater than an amplitude of the background noise. The background noise may include sounds coming from the propellers, carrier, motors, camera, or any other noise-producing component of the movable object. In some instances, the amplitude of the sound signals may vary based on a distance between the user and the movable object. For example, the amplitude of the sound signals may increase as the distance between the user and the movable object increases. Alternatively, the amplitude of the sound signals may decrease as the distance between the user and the movable object increases.

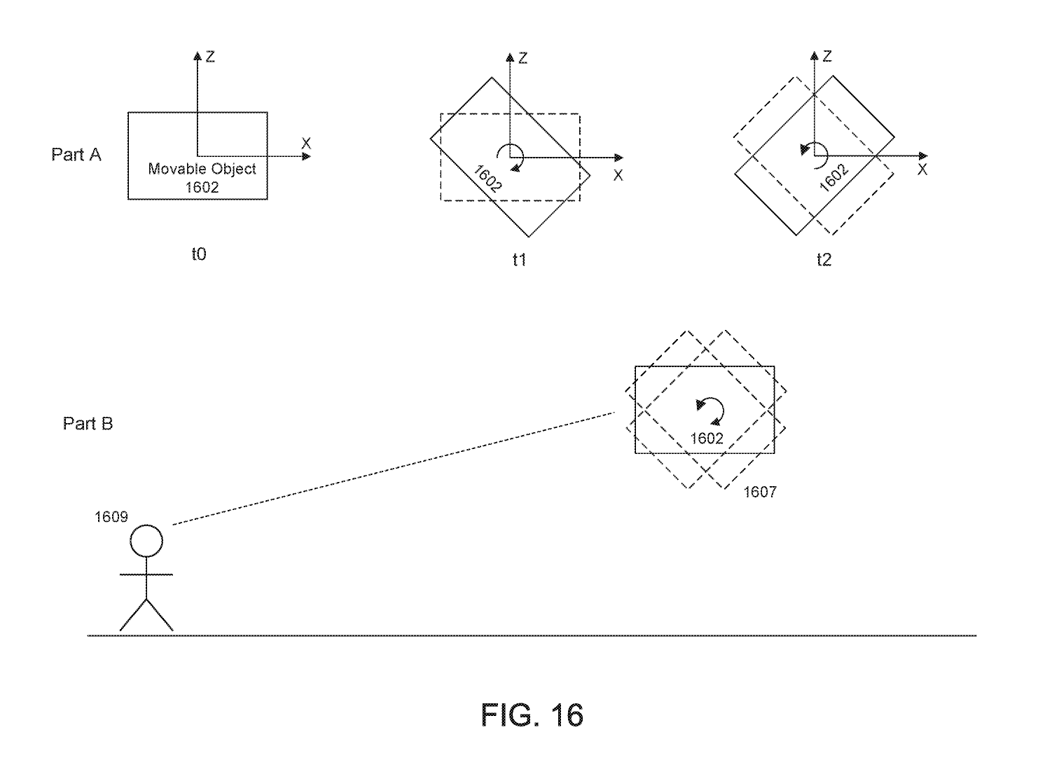

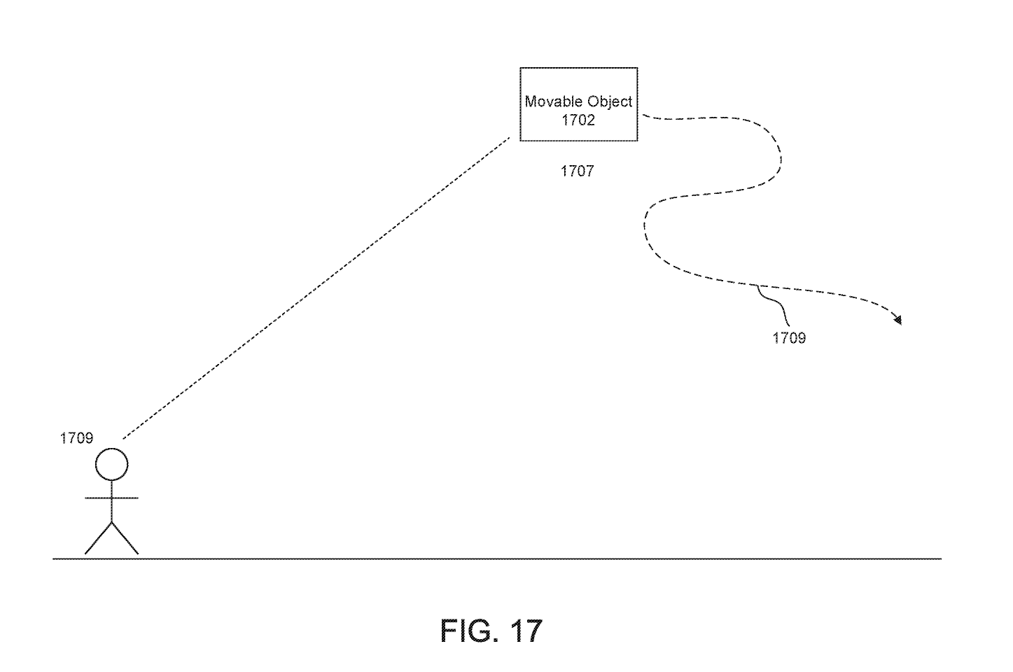

FIGS. 16 and 17 illustrate a movable object exhibiting a motion effect to a remote user as the movable object is performing one or more tasks, in accordance with some embodiments. For example, an application may be configured to control a movable object (1602 and 1702) to perform one or more user-specified tasks. The embodiments of FIGS. 16 and 17 may be similar to the ones in FIGS. 14 and 15, except the movable object is configured to generate a motion effect instead of a visual effect or an audio effect.

In FIGS. 16 and 17, the operational status of the movable object can be conveyed to a remote user through a motion effect. This can be achieved by controlling the movable object to generate the motion effect when the movable object is being operated to perform one or more user-specified tasks. The movable object can be controlled via one or more control signals (previously described in FIG. 13) and the corresponding indicator codes. The control signals and indicator codes may comprise sets of instructions for directing the movable object to behave to generate the motion effect.

The motion effect can be generated by driving one or more propulsion units onboard the movable object to result in (1) a motion pattern of the movable object (for example, as shown in FIG. 16), or (2) movement of the movable object along a predetermined motion path (for example, as shown in FIG. 17). The motion effect of the movable object may be visually discernible to the user.

The motion pattern of the movable object may include a rotation of the movable object about its pitch, roll, and/or yaw axes. For example, in some embodiments, the motion pattern may include a pitching motion, a rolling motion, and/or a yaw motion of the movable object. The angle of pitch, roll, and/or yaw can be controlled by adjusting power to the propulsion units of the movable object via electronic speed control (ESC) units, and can be measured using an inertial measurement unit (IMU) onboard the movable object. The motion pattern may be effected while the movable object is hovering at a stationary spot, or moving in mid-air.

Part A of FIG. 16 illustrates a motion pattern of a movable object 1602 in accordance with some embodiments. In part A, the movable object may be hovering in a stationary spot in mid-air at time t0. Next, the movable object may rotate clockwise about the Y-axis (pitch axis) by a predetermined angle (e.g., 45 degrees) at time t1. Next, the movable object may rotate counter-clockwise about the Y-axis (pitch axis) by a predetermined angle (e.g., 90 degrees) at time t2.

The combined motion pattern of part A is illustrated in part B of FIG. 16. For example, a user 1609 may observe a motion effect 1607 (motion pattern) of the movable object as the movable object is performing a user-specific task in accordance with an application.

As previously described, the motion effect can also include a movement of the movable object along a predetermined motion path. The motion path may be straight (linear), curved, or curvilinear. Points on the motion path may lie on a same plane or on different planes. Movement of the movable object along the motion path can be effected using a flight controller and propulsion units onboard the movable object. The motion path may be substantially fixed, or may be variable or dynamic. The motion path may include a heading in a target direction. The motion path may have a closed shape (e.g., a circle, ellipse, square, etc.) or an open shape (e.g., an arc, a U-shape, etc).

FIG. 17 illustrates movement of a movable object along a predetermined motion path in accordance with some embodiments. A motion effect 1707 may include movement of a movable object 1702 along a motion path 1709. The motion path may be provided in any direction and/or at any altitude in 3-dimensional space. The motion path may be straight (linear), curved, or curvilinear. Points on the motion path may lie on a same plane or on different planes. Movement of the movable object along the motion path can be effected using a flight controller and propulsion units onboard the movable object. The motion path may be substantially fixed, or may be variable or dynamic. The motion path may include a heading in a target direction. The motion path may have a closed shape (e.g., a circle, ellipse, square, etc.) or an open shape (e.g., an arc, a U-shape, etc). The motion path can have a zig-zag pattern, spiral pattern, up-down/left-right/up-down pattern, circular revolving pattern, or any pattern that is achievable using the hardware/firmware configuration of the movable object.

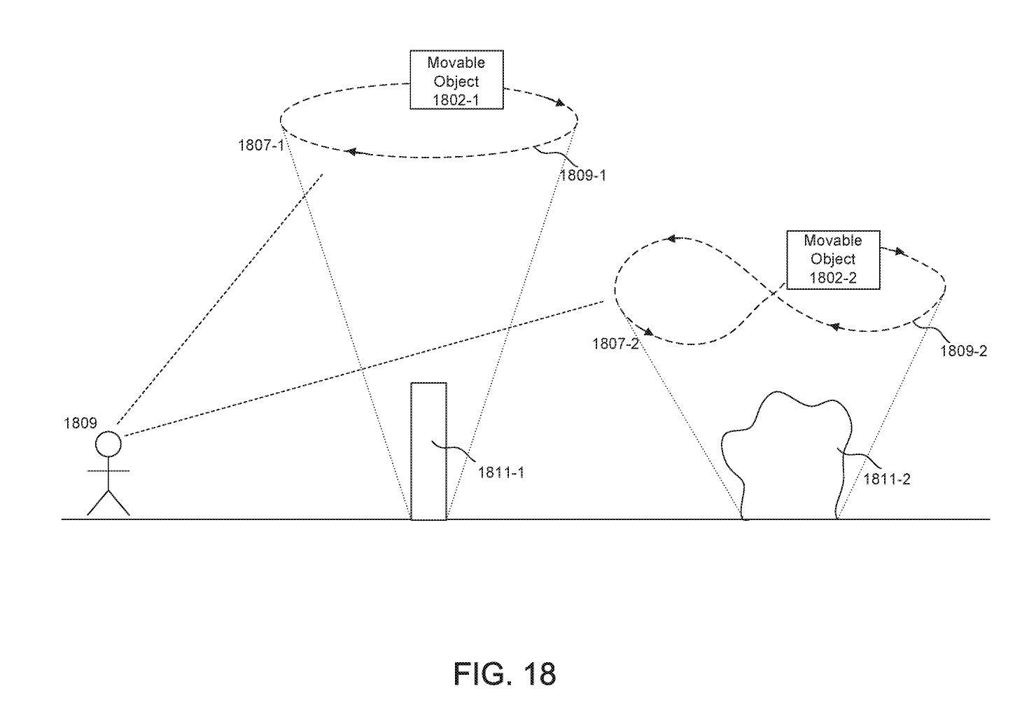

FIG. 18 illustrates movement of a plurality of movable objects along different predetermined motion paths in accordance with some embodiments. In the example of FIG. 18, a user 1809 may be observing a plurality of movable objects (e.g., a first movable object 1802-1 and a second movable object 1802-2) performing different tasks in accordance with different applications. For example, in some embodiments, the first movable object may be configured to follow a first target 1811-1 and the second movable object may be configured to follow a second target 1811-2. The first target may have a regular shape, and the second target may have an irregular shape. The target may be disposed on a ground surface or away from the ground surface. The target may be stationary or capable of motion. A user 1809 may observe different motion effects of the movable objects as the movable objects are performing one or user-specific tasks in accordance with different applications. In particular, the motion effects can help the user to distinguish between different applications.

For example, in one embodiment, a first motion effect 1807-1 may include movement of the first movable object along an elliptical motion path 1809-1. When the user sees the first motion effect 1807-1, the user may be able to immediately recognize that the first movable object is following the first target. The ellipse may be provided in any orientation in 3-dimensional space. In some cases, a perpendicular axis extending through the center of the ellipse may be parallel to the yaw axis of the movable object. Alternatively, a perpendicular axis extending through the center of the ellipse may be oblique to the yaw axis of the movable object. A plane on which the ellipse lies may be horizontal, vertical, or disposed at an angle relative to a reference surface (e.g., a ground plane).

In the example of FIG. 18, a second motion effect 1807-2 may be provided in addition to the first motion effect. The second motion effect is different from the first motion effect, to help the user distinguish which movable object is following which target. In some embodiments, the second motion effect may include movement of the second movable object along a three-dimensional “figure-8” motion path 1809-2. When the user sees the second motion effect 1807-2, the user may be able to immediately recognize that the second movable object is following the second target.

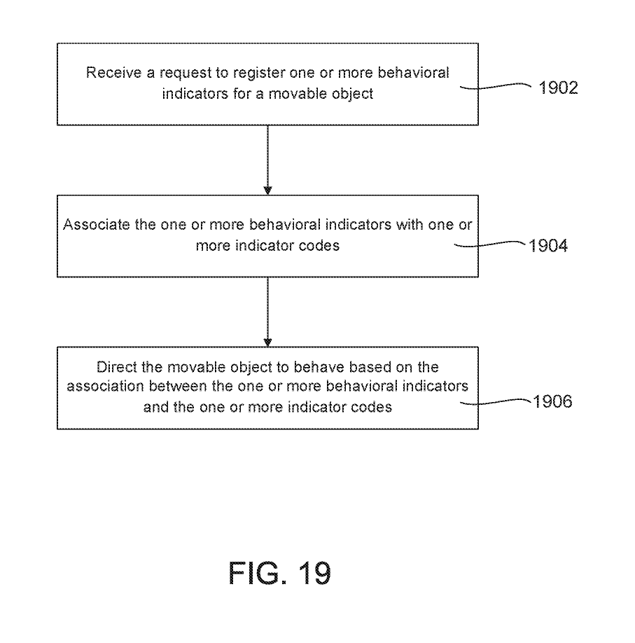

FIG. 19 illustrates a flowchart of a method for controlling a movable object in accordance with some embodiments. First, a request may be received to register one or more behavioral indicators for a movable object (Step 1902). The request may be received by an external device that is remote to the movable object. Alternatively, the request may be received by a device that is onboard the movable object. Optionally, the request may be received by the movable object, or by another movable object.

A movable object controller may be configured to manage communications between the movable object and an external device. Alternatively, the movable object controller may be configured to manage communications between the modules in the movable object and a device onboard the movable object. Optionally, the movable object controller may be configured to manage communications between two or more movable objects.

Next, the request may be processed, by associating the one or more behavioral indicators with one or more indicator codes (Step 1904). In some embodiments, the request may be processed by the movable object controller. Alternatively, the request may be processed by a device (e.g., an external device or on onboard device). Additionally, the request may be processed by one or more processors individually or collectively on the movable object.

Next, the movable object may be directed to behave based on the association between the one or more behavioral indicators and the one or more indicator codes (Step 1906). The behavioral indicators and corresponding indicator codes may include sets of instructions for directing the movable object to behave in a plurality of different predetermined manners, as previously described in FIGS. 12 and 13. A behavior table (e.g., in the form of a look-up table) may be provided. The behavior table may include the behavioral indicators and the corresponding indicator codes. The behavior table may be registered on the movable object. For example, the behavior table may be stored in a memory unit that is accessible by (1) the movable object controller, and/or (2) other modules of the movable object. The behavior table may also accessible by a remote device or an onboard device via the movable object controller. Additionally, the behavior table registered on the movable object may be accessible by another different movable object via the movable object controller.

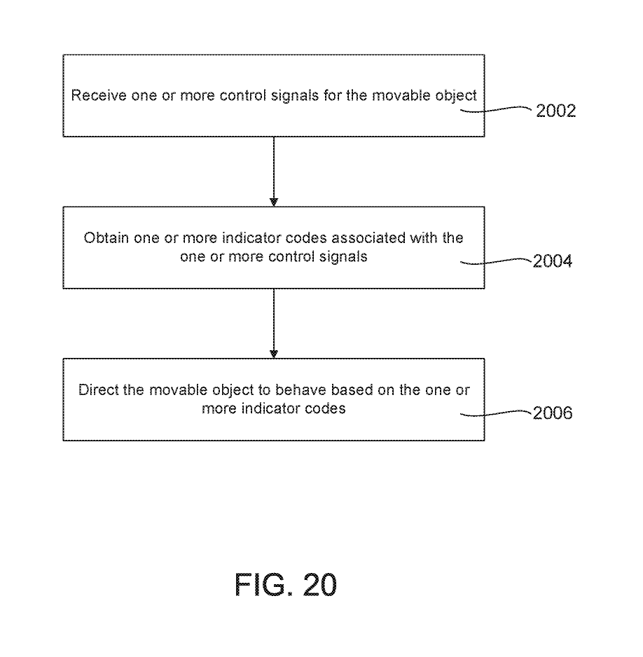

FIG. 20 illustrates a flowchart of a method for controlling a movable object in accordance with some embodiments. First, one or more control signals may be received for a movable object (Step 2002). The control signals may be received by a device, the movable object, or a movable object controller that manages communications between the device and the movable object. The device may be an external device or a device that is onboard the movable object. In some embodiments, the device may be a user terminal. In some alternative embodiments, the device may be located onboard another movable object. The control signals may be provided via an application that is being executed by the device. The control signals may include instructions for the movable object to perform one or more user-specific tasks.

Next, one or more indicator codes associated with the one or more control signals may be obtained (Step 2004). The indicator codes may be obtained by one or more processors onboard the movable object. Alternatively, the indicator codes may be obtained by the device (e.g., remote device or onboard device). The indicator codes may also be obtained by the movable object controller that is in communication with the movable object and the device.

Next, the movable object may be directed to behave based on the one or more indicator codes (Step 2006). For example, when the movable object is performing the one or more user-specific tasks defined within the control signals, the movable object may be directed to behave in a plurality of predetermined manners based on the indicator codes. The behavior of the movable object can convey an operational status of the movable object to a user, for example through a visual effect (see, e.g., FIG. 14), an audio effect (see, e.g., FIG. 15), and/or a motion effect (see, e.g., FIGS. 16, 17, and 18).

In some embodiments, a movable object may include one or more pre-existing indicator signals. The pre-existing indicator signals may be pre-registered on the movable object. The pre-existing indicator signals may be stored in a memory unit onboard the movable object. The pre-existing indicator signals may be preset by a manufacturer of the movable object. Alternatively, the pre-existing indicator signals may be preset by an agency that regulates operation of the movable object. The pre-existing indicator signals may be used to control the movable object to exhibit a visual effect, an audio effect, and/or a motion effect during standard operation of the movable object based on a set of factory pre-set rules.

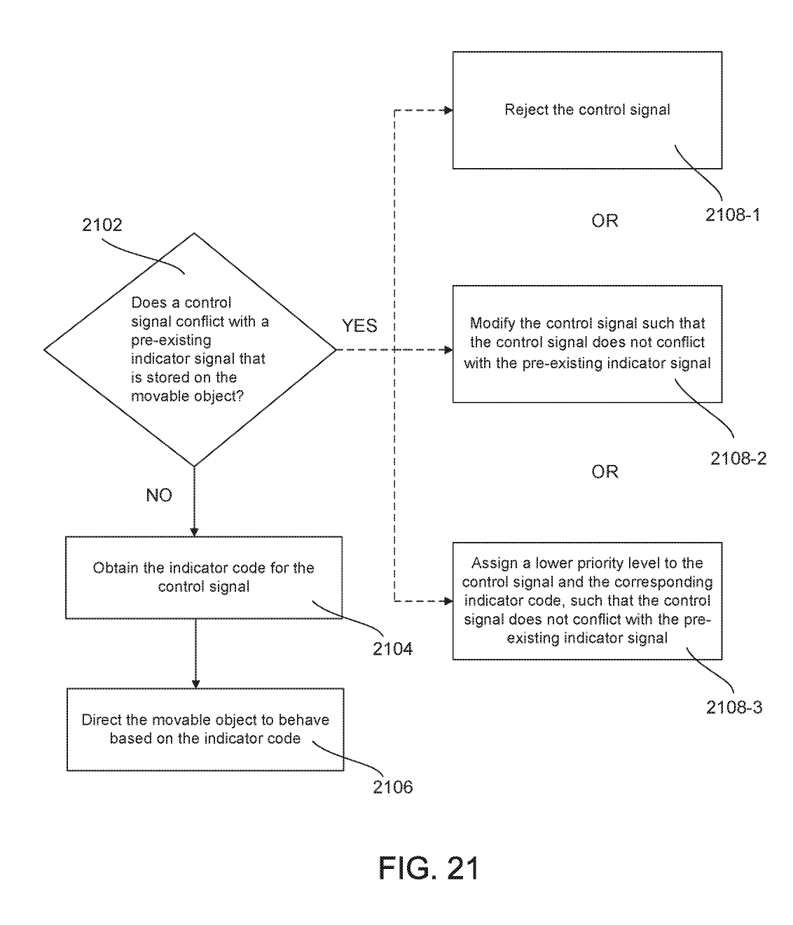

FIG. 21 illustrates a method of controlling a movable object based on whether a control signal conflicts with a pre-existing indicator signal, in accordance with some embodiments. Step 2102 involves determining whether a control signal conflicts with a pre-existing indicator signal that is stored on the movable object. Step 2102 may be performed by a device (e.g., a remote device or an onboard device), one or more processors onboard the movable object, or a movable object controller that manages communication between the movable object and the device. A conflict between the control signal and the pre-existing indicator signal may occur when a behavioral indicator in the control signal generates a similar effect as the pre-existing indicator signal. For example, the behavioral indicator and the pre-existing indicator signal may have a similar visual effect, audio effect, and/or motion effect.

If the control signal does not conflict with the pre-existing indicator signal, then the indicator code for the control signal may be obtained (Step 2104), and the movable object may be directed to behave based on the indicator code (Step 2106).

Conversely, if the control signal conflicts with the pre-existing indicator signal, one or more of the following steps may be taken: (1) reject the control signal (Step 2108-1), (2) modify the control signal such that the behavioral indicator in the control signal does not conflict with the pre-existing indicator signal (Step 2108-2), or (3) assign a lower priority level to the behavioral indicator in the control signal, such that the behavioral indicator in the control signal does not conflict with the pre-existing indicator signal (Step 2108-3). In some alternative embodiments, the behavioral indicator in the control signal may be permitted to override the pre-existing indicator signal.

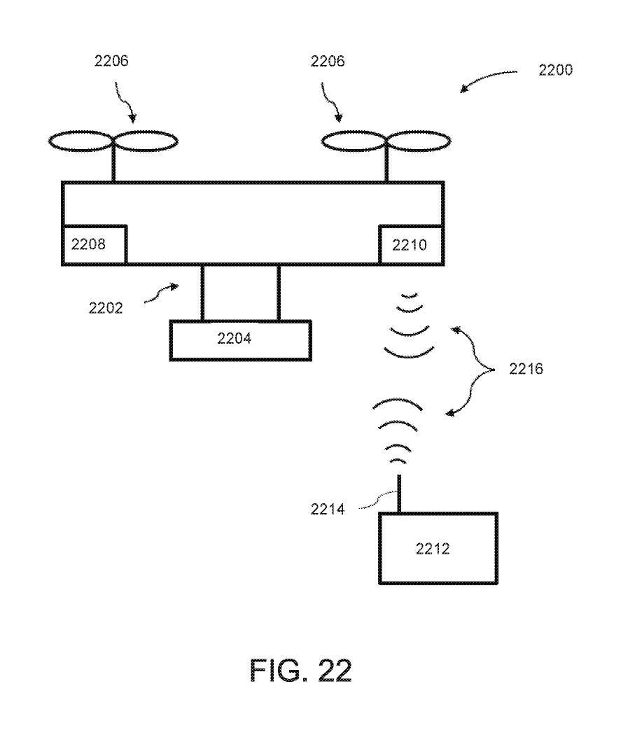

FIG. 22 illustrates a movable object 2200 including a carrier 2202 and a payload 2204, in accordance with embodiments. Although the movable object 2200 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 2204 may be provided on the movable object 2200 without requiring the carrier 2202. The movable object 2200 may include propulsion mechanisms 2206, a sensing system 2208, and a communication system 2210.

The propulsion mechanisms 2206 can include one or more of rotors, propellers, blades, engines, motors, wheels, axles, magnets, or nozzles, as previously described. For example, the propulsion mechanisms 2206 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 2206 can be mounted on the movable object 2200 using any suitable means, such as a support element (e.g., a drive shaft) as described elsewhere herein. The propulsion mechanisms 2206 can be mounted on any suitable portion of the movable object 2200, such on the top, bottom, front, back, sides, or suitable combinations thereof.

In some embodiments, the propulsion mechanisms 2206 can enable the movable object 2200 to take off vertically from a surface or land vertically on a surface without requiring any horizontal movement of the movable object 2200 (e.g., without traveling down a runway). Optionally, the propulsion mechanisms 2206 can be operable to permit the movable object 2200 to hover in the air at a specified position and/or orientation. One or more of the propulsion mechanisms 2200 may be controlled independently of the other propulsion mechanisms. Alternatively, the propulsion mechanisms 2200 can be configured to be controlled simultaneously. For example, the movable object 2200 can have multiple horizontally oriented rotors that can provide lift and/or thrust to the movable object. The multiple horizontally oriented rotors can be actuated to provide vertical takeoff, vertical landing, and hovering capabilities to the movable object 2200. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 2200 (e.g., with respect to up to three degrees of translation and up to three degrees of rotation).

The sensing system 1008 can include one or more sensors that may sense the spatial disposition, velocity, and/or acceleration of the movable object 2200 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 2208 can be used to control the spatial disposition, velocity, and/or orientation of the movable object 2200 (e.g., using a suitable processing unit and/or control module, as described below). Alternatively, the sensing system 2208 can be used to provide data regarding the environment surrounding the movable object, such as weather conditions, proximity to potential obstacles, location of geographical features, location of manmade structures, and the like.

The communication system 2210 enables communication with terminal 2212 having a communication system 2214 via wireless signals 2216. The communication systems 2210, 2214 may include any number of transmitters, receivers, and/or transceivers suitable for wireless communication. The communication may be one-way communication, such that data can be transmitted in only one direction. For example, one-way communication may involve only the movable object 2200 transmitting data to the terminal 2212, or vice-versa. The data may be transmitted from one or more transmitters of the communication system 2210 to one or more receivers of the communication system 2212, or vice-versa. Alternatively, the communication may be two-way communication, such that data can be transmitted in both directions between the movable object 2200 and the terminal 2212. The two-way communication can involve transmitting data from one or more transmitters of the communication system 1010 to one or more receivers of the communication system 2214, and vice-versa.

In some embodiments, the terminal 2212 can provide control data to one or more of the movable object 2200, carrier 2202, and payload 2204 and receive information from one or more of the movable object 2200, carrier 2202, and payload 2204 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 2206), or a movement of the payload with respect to the movable object (e.g., via control of the carrier 2202). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 2208 or of the payload 2204). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 2212 can be configured to control a state of one or more of the movable object 2200, carrier 2202, or payload 2204. Alternatively or in combination, the carrier 2202 and payload 2204 can also each include a communication module configured to communicate with terminal 2212, such that the terminal can communicate with and control each of the movable object 2200, carrier 2202, and payload 2204 independently.

In some embodiments, the movable object 2200 can be configured to communicate with another remote device in addition to the terminal 2212, or instead of the terminal 2212. The terminal 2212 may also be configured to communicate with another remote device as well as the movable object 2200. For example, the movable object 2200 and/or terminal 2212 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 2200, receive data from the movable object 2200, transmit data to the terminal 2212, and/or receive data from the terminal 2212. Optionally, the remote device can be connected to the Internet or other telecommunications network, such that data received from the movable object 2200 and/or terminal 2212 can be uploaded to a website or server.

In some embodiments, a system for controlling a movable object may be provided in accordance with embodiments. The system can be used in combination with any suitable embodiment of the systems, devices, and methods disclosed herein. The system can include a sensing module, processing unit, non-transitory computer readable medium, control module, and communication module.

The sensing module can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module can be operatively coupled to a processing unit having a plurality of processors. In some embodiments, the sensing module can be operatively coupled to a transmission module (e.g., a Wi-Fi image transmission module) configured to directly transmit sensing data to a suitable external device or system. For example, the transmission module can be used to transmit images captured by a camera of the sensing module to a remote terminal.

The processing unit can have one or more processors, such as a programmable processor (e.g., a central processing unit (CPU)). The processing unit can be operatively coupled to a non-transitory computer readable medium. The non-transitory computer readable medium can store logic, code, and/or program instructions executable by the processing unit for performing one or more steps. The non-transitory computer readable medium can include one or more memory units (e.g., removable media or external storage such as an SD card or random access memory (RAM)). In some embodiments, data from the sensing module can be directly conveyed to and stored within the memory units of the non-transitory computer readable medium. The memory units of the non-transitory computer readable medium can store logic, code and/or program instructions executable by the processing unit to perform any suitable embodiment of the methods described herein. For example, the processing unit can be configured to execute instructions causing one or more processors of the processing unit to analyze sensing data produced by the sensing module. The memory units can store sensing data from the sensing module to be processed by the processing unit. In some embodiments, the memory units of the non-transitory computer readable medium can be used to store the processing results produced by the processing unit.

In some embodiments, the processing unit can be operatively coupled to a control module configured to control a state of the movable object. For example, the control module can be configured to control the propulsion mechanisms of the movable object to adjust the spatial disposition, velocity, and/or acceleration of the movable object with respect to six degrees of freedom. Alternatively or in combination, the control module can control one or more of a state of a carrier, payload, or sensing module.

The processing unit can be operatively coupled to a communication module configured to transmit and/or receive data from one or more external devices (e.g., a terminal, display device, or other remote controller). Any suitable means of communication can be used, such as wired communication or wireless communication. For example, the communication module can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module can transmit and/or receive one or more of sensing data from the sensing module, processing results produced by the processing unit, predetermined control data, user commands from a terminal or remote controller, and the like.

The components of the system can be arranged in any suitable configuration. For example, one or more of the components of the system can be located on the movable object, carrier, payload, terminal, sensing system, or an additional external device in communication with one or more of the above. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system can occur at one or more of the aforementioned locations.

As used herein A and/or B encompasses one or more of A or B, and combinations thereof such as A and B. It will be understood that although the terms “first,” “second,” “third” etc. may be used herein to describe various elements, components, regions and/or sections, these elements, components, regions and/or sections should not be limited by these terms. These terms are merely used to distinguish one element, component, region or section from another element, component, region or section. Thus, a first element, component, region or section discussed below could be termed a second element, component, region or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the figures. It will be understood that relative terms are intended to encompass different orientations of the elements in addition to the orientation depicted in the figures. For example, if the element in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the element in one of the figures were turned over, elements described as “below” or “beneath” other elements would then be oriented “above” the other elements. The exemplary terms “below” or “beneath” can, therefore, encompass both an orientation of above and below.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A method for supporting application development in a movable object environment, comprising:
receiving, via a movable object controller, a request to register one or more behavioral indicators for a movable object;
associating the one or more behavioral indicators with one or more indicator codes; and
directing the movable object to behave based on an association between the one or more behavioral indicators and the one or more indicator codes.

2. The method of claim 1, wherein the movable object is directed to behave based on the association when the movable object operates to perform one or more tasks defined by one or more control signals.

3. The method of claim 2, wherein the movable object is operated using a remote controller configured to receive a user input or is autonomously operated using a flight controller onboard the movable object.

4. The method of claim 1, wherein the one or more indicator codes are pre-registered on the movable object.

5. The method of claim 1, wherein:
the one or more behavioral indicators are associated with the one or more indicator codes using one or more processors located onboard the movable object; and
the movable object is configured to transmit the one or more indicator codes to a device via the movable object controller.

6. The method of claim 1, wherein:
the one or more behavioral indicators are associated with the one or more indicator codes using one or more processors located on a device; and
the device is configured to transmit the one or more indicator codes to the movable object via the movable object controller.

7. The method of claim 1, wherein the one or more behavioral indicators and the one or more indicator codes comprise sets of instructions for directing the movable object to behave in a plurality of predetermined manners.

8. The method of claim 7, wherein the plurality of predetermined manners comprise at least one of a visual effect, an audio effect, or a motion effect.

9. The method of claim 8, wherein the visual effect is generated by driving one or more light-emitting elements onboard the movable object, the one or more light-emitting elements being configured to emit light of a same color or different colors.

10. The method of claim 9, wherein the visual effect comprises a predetermined sequence of light flashes at a same time interval or at different time intervals.

11. The method of claim 8, wherein the audio effect is generated by driving one or more speakers onboard the movable object, the one or more speakers being configured to emit sound of a same frequency or different frequencies.

12. The method of claim 11, wherein the audio effect comprises a predetermined sequence of sounds at a same time interval or different time intervals.

13. The method of claim 8, wherein the motion effect is generated by driving one or more propulsion units onboard the movable object to result in (1) a motion pattern of the movable object, or (2) movement of the movable object along a predetermined motion path.

14. The method of claim 13, wherein the motion pattern comprises at least one of a pitch motion, a roll motion, or a yaw motion of the movable object.

15. The method of claim 1, wherein the movable object includes an unmanned vehicle, a hand-held device, or a robot.

16. The method of claim 1, wherein the one or more behavioral indicators and the one or more indicator codes are provided in a look-up table and stored in a memory unit accessible by the movable object controller.

17. The method of claim 1, wherein the movable object controller is in communication with one or more applications via a movable object manager comprising a communication adaptor.

18. The method of claim 17, wherein:
the movable object is an unmanned aircraft; and
the communication adaptor comprises:
a camera component;
a battery component;
a gimbal component;
a communication component;
a flight controller component; and
a ground station component that is associated with the flight controller component, the ground station component operating to perform one or more flight control operations.

19. A system for supporting application development in a movable object environment, the system comprising a movable object controller configured to:
receive a request to register one or more behavioral indicators for a movable object;
associate the one or more behavioral indicators with one or more indicator codes; and
direct the movable object to behave based on an association between the one or more behavioral indicators and the one or more indicator codes.

20. A non-transitory computer-readable medium storing instructions that, when executed, causes one or more processors to individually or collectively perform a method for supporting application development in a movable object environment, the method comprising:
receiving a request to register one or more behavioral indicators for a movable object;
associating the one or more behavioral indicators with one or more indicator codes; and
directing the movable object to behave based on an association between the one or more behavioral indicators and the one or more indicator codes.
